(19) United States
(12) Patent Application Publication
(10) Pub. No.: US 2007/0069981 A1
(43) Pub. Date: Mar. 29, 2007

(54) Plasma display apparatus

(75) Inventors: Kirack Park, Chilgok-gun (KR); Jongwoon Bae, Gumi-si (KR); Seonghwan Ryu, Gumi-si (KR); Yoonjoo Cho, Seoul (KR); Dooyong Hwang, Yongin-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/292,097

(22) Filed: Dec. 2, 2005

(30) Foreign Application Priority Data
Sep. 23, 2005 (KR) 10-2005-0089004

(51) Int. Cl. G09G 3/28

(52) U.S. Cl. 345/60

(57) ABSTRACT

The present invention relates to a plasma display apparatus of scanning a scan electrode Y with one or more scan types among a plurality of scan types. The present invention has an effect of preventing the excessive displacement current from beign generated by scanning the scan electrodes with any one of a plurality of scan types, and thus preventing electrical damage to the data driver integrated circuit. The present invention is preferred to include a plurality of scan electrodes, a plurality of data electrodes intersecting the plurality of scan electrodes, a scan driver for scanning the scan electrode with one scan type among a plurality of scan types in which an order of scanning the plurality of scan electrodes is different from each other in an address period, and causing the width of scan pulse supplied to a first scan electrode among the plurality of scan electrodes upon scanning the scan electrode to be different from the width of scan pulse supplied to a second scan electrode having a different scan order from the first scan electrode, and a data driver of supplying a data pulse to the data electrode corresponding to the one scan type.

### CROSS-REFERENCES TO RELATED APPLICATIONS

This Nonprovisional application claims priority under 35 U.S.C. § 119(a) on Patent Application No. 10-2005-0089004 filed in Korea on Sep. 23, 2005, the entire contents of which are hereby incorporated by reference.

### BACKGROUND OF THE INVENTION

1. Field of the Invention

The present invention relates to a plasma display apparatus, and more particularly, to a plasma display apparatus of scanning a scan electrode Y with one or more scan types among a plurality of scan types.

2. Background of the Related Art

In a conventional plasma display panel, barrier ribs formed between a front panel and a rear panel of the panel constitute a cell, and an inert gas containing a main discharge gas such as Ne, He, or mixture gas of Ne+He and small amount of Xe is injected into each cell. This plurality of cells constitutes a pixel. For example, a red, a green, and a blue cells constitute a pixel.

In the plasma display panel, when a discharge occurs due to a high frequency voltage, the inert gas generates vacuum ultraviolet rays and a phosphor body formed between the barrier ribs is lit by the vacuum ultraviolet rays to thereby implement an image. Since the plasma display panel can be manufactured to be thin and light weight, it is considered as one of the most popular next generation displays.

The plasma display panel is formed with a plurality of electrodes, for example, a scan electrode Y, a sustain electrode Z, and a data electrode X, and the image is displayed by supplying a predetermined driving voltage to the plurality of electrodes to thereby cause a discharge to occur. A driver integrated circuit is connected to the electrodes to supply the driving voltage to the electrodes of the plasma display panel.

For example, a data driver integrated circuit is connected to the data electrode among the electrodes of the plasma display panel and a scan driver integrated circuit is connected to the scan electrode Y.

A displacement current ID flows in the driver integrated circuit upon driving the plasma display panel, the displacement current is varied depending on various factors.

For example, the displacement current flowing in the data driver integrated circuit is increased or decreased depending on the number of times the data driver integrated circuit switched and equivalent capacitance C of the plasma display panel, and more specifically, the displacement current in the data driver integrated circuit increases as the equivalent capacitance C of the plasma display panel increases and the number of times the data driver integrated circuit switched increases.

The equivalent capacitance C is determined depending on the equivalent capacitances between the electrodes, which will be described with reference to FIG. 1.

FIG. 1 illustrates an equivalent capacitance C of a plasma display panel.

Referring to FIG. 1, an equivalent capacitance C comprises an equivalent capacitance Cm1 between the data electrodes, for example, a X1 data electrode and a X2 data electrode, and an equivalent capacitance Cm2 between a data electrode and a scan electrode, for example, the X1 data electrode and a Y1 scan electrode, and an equivalent capacitance Cm2 between the data electrode and a sustain electrode, for example, the X1 data electrode and a Z1 sustain electrode.

Since the voltage applied to the scan electrode Y and data electrode X varies depending on the operation of a switching element included in a driver integrated circuit, for example, a scan driver integrated circuit for supplying a scan pulse to the scan electrode Y in an address period to drive the scan electrode Y, and a driver integrated circuit, for example, a data driver integrated circuit for supplying a data pulse to the data electrode X in the address period to drive the data electrode X, the displacement current Id generated by the Cm1 and Cm2 equivalent capacitances flows through the data electrode X directly to the data driver integrated circuit.

As mentioned above, as the equivalent capacitance of the plasma display panel increases, the displacement current Id flowing in the data driver integrated circuit increases. And likewise, as the number of times the data driver integrated circuit switched increases, the displacement current Id also increases, the number of times the data driver integrated circuit switched being varied depending on the inputted image data.

There is a problem in that electrical damage to the data driver integrated circuit occurs because the displacement current overflows into the data driver integrated circuit when the image data has a specific pattern in which logic values, 1 and 0 are repeated.

### SUMMARY OF THE INVENTION

Accordingly, an object of the present invention is to solve at least the problems and disadvantages of the background art.

To solve the problems, the object of the present invention is to provide a plasma display apparatus in which a plurality of scan types are provided and the scanning is performed with one or more scan types selected from the plurality of scan types, and thus preventing the electrical damage to the driver integrated circuit.

To accomplish the above object, a plasma display apparatus of the present invention comprises a plurality of scan electrodes, a plurality of data electrodes intersecting the plurality of scan electrodes, a scan driver for scanning a scan electrode with one scan type among a plurality of scan types in which an order of scanning the plurality of scan electrodes is different from each other in an address period, and causing the width of scan pulse supplied to a first scan electrode among the plurality of scan electrodes upon scanning the scan electrode to be different from the width of the scan pulse supplied to a second scan electrode having a different scan order from the first scan electrode, and a data driver for supplying a data pulse to the data electrode corresponding to the one scan type.

Further, to accomplish the above object, a plasma display apparatus of the present invention comprises a plurality of scan electrodes, a plurality of data electrodes intersecting the plurality of scan electrodes, a scan driver for scanning the scan electrode with one scan type among a plurality of scan types in which an order of scanning the plurality of scan electrodes is different from each other in an address period, and causing the magnitude of the voltage of the scan pulse supplied to a first scan electrode among the plurality of scan electrodes upon scanning the scan electrode to be different from the magnitude of the voltage of the scan pulse supplied to a second scan electrode having a different scan order from the first scan electrode, and a data driver of supplying a data pulse to the data electrode corresponding to the one scan type.

Further, to accomplish the above object, a plasma display apparatus of the present invention comprises a plasma display panel on which a plurality of scan electrodes are formed, and a plurality of data electrodes intersecting the plurality of scan electrodes are formed, a scan driver for scanning the scan electrode with one scan type among a plurality of scan types in which an order of scanning the plurality of scan electrodes is different from each other in an address period, and causing, in case where the temperature of the plasma display panel is a first temperature, the width of scan pulse supplied to the scan electrode upon scanning the scan electrode to be different from, in case where the temperature of the plasma display panel is a second temperature different from the first temperature, the width of scan pulse supplied to the scan electrode, and a data driver of supplying a data pulse to the data electrode corresponding to the one scan type.

Further, to accomplish the above object, a plasma display apparatus of the present invention comprises a plasma display panel on which a plurality of scan electrodes are formed, and a plurality of data electrodes intersecting the plurality of scan electrodes are formed, a scan driver for scanning the scan electrode with one scan type among a plurality of scan types in which an order of scanning the plurality of scan electrodes is different from each other in an address period, and causing, in case where the temperature of the plasma display panel is a first temperature, the magnitude of the voltage of the scan pulse supplied to the scan electrode upon scanning the scan electrode to be different from, in case where the temperature of the plasma display panel is the second temperature different from the first temperature, the magnitude of the voltage of the scan pulse supplied to the scan electrode, and a data driver of supplying a data pulse to the data electrode corresponding to the one scan type.

Further, to accomplish the above object, a plasma display apparatus of the present invention comprises a plasma display panel on which a plurality of scan electrodes and a plurality of data electrodes intersecting the plurality of scan electrodes are formed, a scan driver of causing the scan order of the plurality of scan electrodes different from a first data pattern in a second data pattern to be different from the first data pattern among the data patterns of inputted image data to scan the scan electrode, and causing the width of scan pulse supplied to a first scan electrode among the plurality of scan electrodes upon scanning the scan electrode to be different from the width of scan pulse supplied to a second scan electrode having a different scan order from the first scan electrode, and a data driver of supplying a data pulse to the data electrode corresponding to the one scan type.

As mentioned in detail above, the present invention prevents the excessive displacement of current from being generated by scanning the scan electrodes Y with any one of a plurality of scan types, and thus preventing electrical damage to the data driver integrated circuit.

The present invention has also prevents undesired discharges due to temperature by adjusting the width of scan pulse and/or the magnitude of the voltage of the scan pulse according to the scan order in the address period and by adjusting the width of scan pulse and/or the magnitude of the voltage of the scan pulse according to the temperature of the plasma display panel.

### BRIEF DESCRIPTION OF THE DRAWINGS

The invention will be described in detail with reference to the following drawings in which like numerals refer to like elements.

FIG. 1 illustrates an equivalent capacitance C of a plasma display panel.

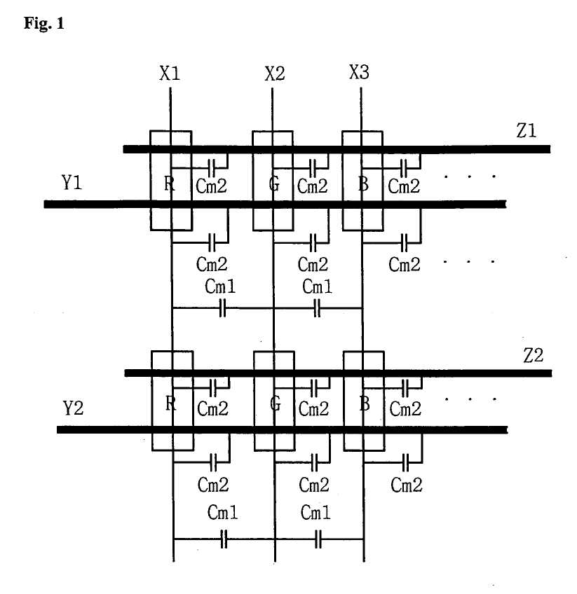

FIG. 2 illustrates a plasma display apparatus of the present invention.

FIGS. 3a and 3b illustrate an embodiment of a plasma display panel structure according to the present invention.

FIG. 4 illustrates a method of implementing a gray scale of an image in a plasma display apparatus of the present invention.

FIG. 5 illustrates a maginitude of the displacement current according to inputted image data.

FIGS. 6a and 6b illustrate an embodiment of a method of changing a scan order considering image data and a displacement current according to the image data.

FIG. 7 illustrates another embodiment in a driving method of a plasma display apparatus of the present invention.

FIG. 8 is a detailed view for illustrating a configuration and an operation of a scan driver for implementing a driving method of a plasma display apparatus of the present invention.

FIG. 9 is a block diagram of a basic circuit included in a data comparison unit 1000 included in a scan driver of a plasma display apparatus of the present invention.

FIG. 10 is a detailed view for illustrating an operation of a first to a third determination units of a data comparison unit.

FIG. 11 illustrates a pattern of image data according to an outputted signal of a first to a third determination unit 734-1, 734-2, 734-3 included in a basic circuit block of a data comparison unit of the present invention.

FIG. 12 is a block diagram of data comparison unit 1000 and a scan order determination unit 1001 of a scan driver in a plasma display apparatus of the present invention.

FIG. 13 illustrates a pattern of image data according to an output signal of a first to a third determination unit XOR1, XOR2, XOR3 included in a data comparison unit of the present invention.

FIG. 14 is another block diagram of a basic circuit included in a data comparison unit 1000 included in a scan driver of a plasma display apparatus of the present invention.

FIG. 15 illustrates a pattern of an image data according to an output signal of a first to a ninth determination unit XOR1˜XOR9 included in the circuit block of FIG. 21 of the present invention.

FIG. 16 is a block diagram of data comparison unit 1000 and a scan order determination unit 1001 of a scan driver in a plasma display apparatus of the present invention considering FIGS. 14 and 15.

FIG. 17 is a block diagram of an embodiment in which a scan comparison unit and a scan order determination unit are applied on each subfield basis.

FIG. 18 illustrates an embodiment of a method of selecting a subfield scanning the scan electrodes with any one of a plurality of scan types within a frame.

FIG. 19 illustrates a possibility that the scan orders may differ from one another in a pattern of two different image data.

FIG. 20 illustrates an embodiment of a method of adjusting a scan order by establishing a threshold value according to a pattern of an image data.

FIG. 21 illustrates an embodiment of a method of determining a scan order corresponding to scan electrode groups, each including a plurality of scan electrodes Y.

FIGS. 22a to 22c illustrate an embodiment of a method of varying a width of a scan pulse supplied to a scan electrode Y according to a scan order of the scan electrode Y in a driving method of a plasma display apparatus of the present invention.

FIGS. 23a and 23b illustrate a reason for causing the widths of each scan pulse supplied to two scan electrodes to be different from each other in a scan order different from each other.

FIG. 24 illustrates an embodiment of a method of causing the difference in the width of a scan pulse between the scan pulses to be constant.

FIG. 25 illustrates an embodiment of a method of causing the difference in the width of a scan pulse between scan pulses to be different.

FIG. 26 illustrates a variation of a distribution of wall charges in an address period in a driving method of the present invention.

FIG. 27 illustrates an embodiment of a method causing a width of a pulse between scan pulses to be different in a second scan type (Type2).

FIGS. 28a and 28b a for illustrate an embodiment of a method of varying a maginitude of a voltage of a scan pulse supplied to a scan electrode Y according to a scan order of the scan electrode Y in a driving method of a plasma display apparatus of the present invention.

FIG. 29 illustrates an embodiment of a method of causing the difference in voltage of a scan pulse between scan pulses to be constant.

FIG. 30 illustrates an embodiment of a method of causing the difference in voltage of a scan pulse between scan pulses to be different.

FIG. 31 illustrates an embodiment of a method causing a magnitude of voltage of pulse between scan pulses to be different in a second scan type (Type2).

FIGS. 32a and 32b illustrate an embodiment of a method of varying a width of a scan pulse supplied to a scan electrode Y according to temperature of a plasma display panel in a driving method of a plasma display apparatus of the present invention.

FIG. 33 illustrates a reason for adjusting a width of a scan pulse according to the temperature of a plasma display panel.

FIG. 34 illustrates an embodiment of a method for adjusting a width of a scan pulse by establishing a threshold temperature.

FIGS. 35a and 35b illustrate an embodiment of a method of varying a magnitude of a voltage of a scan pulse supplied to a scan electrode Y according to the temperature of a plasma display panel in a driving method of a plasma display apparatus of the present invention.

FIG. 36 illustrates an embodiment of a method of adjusting a magnitude of voltage a of a scan pulse by establishing a threshold temperature.

### DETAILED DESCRIPTION OF PREFERRED EMBODIMENTS

Preferred embodiments of the present invention will be described in a more detailed manner with reference to the drawings.

To accomplish the above objects, a plasma display apparatus comprises a plurality of scan electrodes, a plurality of data electrodes intersecting the plurality of scan electrodes, a scan driver for scanning the scan electrode with one scan type among a plurality of scan types in which an order of scanning the plurality of scan electrodes is different from each other in an address period, and causing the width of a scan pulse supplied to a first scan electrode among the plurality of scan electrodes upon scanning the scan electrode to be different from the width of a scan pulse supplied to a second scan electrode having a different scan order from the first scan electrode, and a data driver of supplying a data pulse to the data electrode corresponding to the one scan type.

The scan driver calculates the displacement current corresponding to each of the plurality of scan types depending on inputted image data, and scans the scan electrode with one scan type having the lowest displacement current among the plurality of scan types.

The scan electrode comprises a first and a second scan electrodes which are divided by a predetermined number of scan electrodes according to the scan types, the data electrode comprises a first and a second data electrodes, a first and a second discharge cells arranged in the intersecting portion of the first scan electrode and first and second data electrodes, and a third and a fourth discharge cells arranged in the intersecting portion of the second scan electrode and the first and second data electrodes are included, the scan driver compares the data of the first to fourth discharge cells and calculates the displacement current for the first discharge cell.

The scan driver finds a first result which comes from the comparison of data of the first discharge cell with data of the second discharge cell, a second result which comes from the comparison of data of the first discharge cell with data of the third discharge cell, a third result which comes from the comparison of data of the third discharge cell with data of the fourth discharge cell, determines a productive equation of the displacement current depending on the combination of the first to third results, and produces a total displacement current of the first discharge cell by summing the displacement current determined using the determined productive equation.

If a capacitance between adjacent data electrodes is Cm1, a capacitance between a data electrode and a scan electrode and a capacitance between data electrode and a sustain electrode are Cm2, the scan driver produces the displacement current according to the combination of the first to third results based on the Cm1 and Cm2.

The scan driver produces a displacement current for the plurality scan types in each subfield of one frame, and scans the scan electrode with the scan type having the lowest displacement current in each subfield.

The scan type comprises a first scan type, the first scan type dividing the scan electrode into a plurality of groups to scan the scan electrode, the scan driver continuously scans each scan electrode included in the same group in the first scan type, in case where the first scan type is the scan type having the lowest displacement current.

The scan driver calculates a displacement current corresponding to each of the plurality of scan types depending on the inputted image data, and scans the scan electrode with at least any one of the scan types having the displacement current that is less than a predetermined threshold displacement current among the plurality of scan types.

The first scan electrode precedes the second scan electrode in scan order, the scan driver causes the width of scan pulse supplied to the second scan electrode to be wider than the width of scan pulse supplied to the first scan electrode.

The width of the scan pulse supplied to the second scan electrode exceeds one time and is less than 2 times the width of scan pulse supplied to the first scan electrode.

To accomplish the above objects, another plasma display apparatus of the present invention comprises a plurality of scan electrodes, a plurality of data electrodes intersecting the plurality of scan electrodes, a scan driver for scanning the scan electrode with one scan type among a plurality of scan types in which an order of scanning the plurality of scan electrodes is different from each other in an address period, and causing the magnitude of the voltage of the scan pulse supplied to a first scan electrode among the plurality of scan electrodes upon scanning the scan electrode to be different from the magnitude of the voltage of the scan pulse supplied to a second scan electrode having a different scan order from the first scan electrode, and a data driver of supplying a data pulse to the data electrode corresponding to the one scan type.

The first scan electrode precedes the second scan electrode in scan order, the scan driver causes the magnitude of the voltage of the scan pulse supplied to the second scan electrode to be more than the magnitude of the voltage of the scan pulse supplied to the first scan electrode.

The magnitude of the voltage of the scan pulse supplied to the second scan electrode exceeds one time and is less than 1.5 times of the magnitude of the voltage of the scan pulse supplied to the first scan electrode.

To accomplish the above objects, another plasma display apparatus of the present invention comprises a plasma display panel on which a plurality of scan electrodes are formed, and a plurality of data electrodes intersecting the plurality of scan electrodes are formed, a scan driver for scanning the scan electrode with one scan type among a plurality of scan types in which an order of scanning the plurality of scan electrodes is different from each other in an address period, and causing, in case where the temperature of the plasma display panel is a first temperature, the width of scan pulse supplied to the scan electrode upon scanning the scan electrode to be different from, in case where the temperature of the plasma display panel is a second temperature different from the first temperature, the width of scan pulse supplied to the scan electrode, and a data driver of supplying a data pulse to the data electrode corresponding to the one scan type.

The first temperature is less than the second temperature, the scan driver causes the width of the scan pulse supplied to the scan electrode in the second temperature to be wider than the width of scan pulse supplied to the scan electrode in the first temperature.

The width of pulse of scan pulse supplied to the scan electrode in the second temperature exceeds one time and is less than 2 times the width of pulse of the scan pulse supplied to the scan electrode in the first temperature.

To accomplish the above object, another plasma display apparatus of the present invention comprises a plasma display panel on which a plurality of scan electrodes are formed, and a plurality of data electrodes intersecting the plurality of scan electrodes are formed, a scan driver for scanning the scan electrode with one scan type among a plurality of scan types in which an order of scanning the plurality of scan electrodes is different from each other in an address period, and causing, in case where the temperature of the plasma display panel is a first temperature, the magnitude of the voltage of the scan pulse supplied to the scan electrode upon scanning the scan electrode to be different from, in case where the temperature of the plasma display panel is a second temperature different from the first temperature, the magnitude of the voltage of the scan pulse supplied to the scan electrode, and a data driver of supplying a data pulse to the data electrode corresponding to the one scan type.

The first temperature is less than the second temperature, the scan driver causes the magnitude of the voltage of the scan pulse supplied to the scan electrode in the second temperature to be more than the magnitude of the voltage of the scan pulse supplied to the scan electrode in the first temperature.

The magnitude of the voltage of the scan pulse supplied to the scan electrode in the second temperature exceeds one time and is less than 1.5 times of the magnitude of the voltage of the scan pulse supplied to the scan electrode in the first temperature.

To accomplish the above object, another plasma display apparatus of the present invention comprises a plasma display panel on which a plurality of scan electrodes and a plurality of data electrodes intersecting the plurality of scan electrodes are formed, a scan driver of causing the scan order of the plurality of scan electrodes to be different from a first data pattern in a second data pattern different from the first data pattern among the data patterns of the inputted image data to scan the scan electrode, and causing the width of the scan pulse supplied to a first scan electrode among the plurality of scan electrodes upon scanning the scan electrode to be different from the width of scan pulse supplied to a second scan electrode having a different scan order from the first scan electrode, and a data driver of supplying a data pulse to the data electrode corresponding to the one scan type.

Hereafter, a plasma display apparatus and a driving method thereof of the present invention will be described in a more detailed manner with reference to the accompanying drawings.

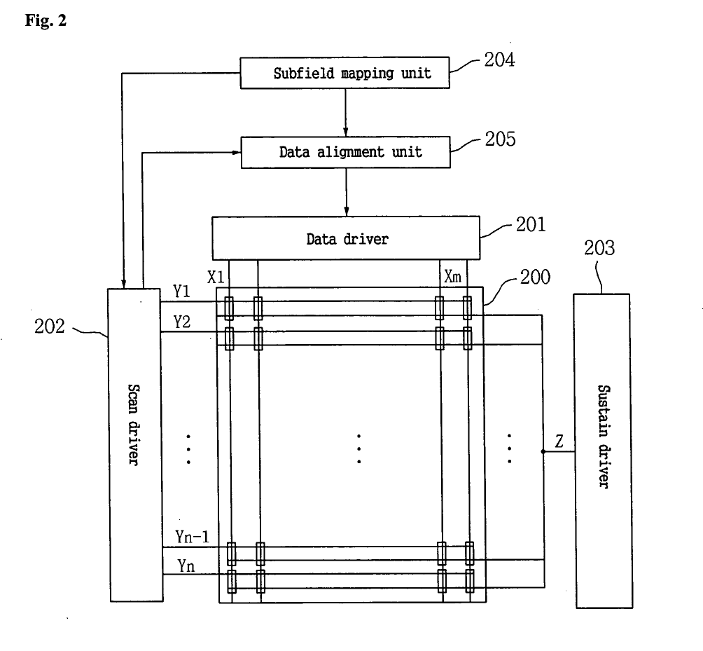

FIG. 2 illustrates a plasma display apparatus of the present invention.

Referring to FIG. 2, a plasma display apparatus of the present invention comprises a plasma display panel 200, a data driver 201, a scan driver 202, a sustain driver 203, a subfield mapping unit 204 and a data alignment unit 205.

In the plasma display panel 200, a front panel (not shown) and a rear panel (not shown) are combined with a predetermined distance in between, and a plurality of electrodes, for example, a scan electrode Y and a sustain electrode Z formed in parallel with the scan electrode Y are provided, respectively. A data electrode X is provided in the direction intersecting the scan electrode Y and sustain electrode Z.

A scan driver 202 supplies a rising ramp waveform Ramp-up and a falling ramp waveform Ramp-down to the scan electrode Y during a reset period. The scan electrode 202 also supplies a sustain pulse SUS to the scan electrode Y during a sustain period. In particular, the scan driver 202 scans a scan electrode Y with one scan type among a plurality of scan types in which the order of scanning the plurality of scan electrodes is different from each other in an address period. In other words, the scan pulse Sp of a negative scan voltage −Vy is supplied to the scan electrode Y during the address period according to one of the plurality of scan types.

The scan driver 202 adjusts the width of pulse and/or the magnitude of the voltage of the scan pulse according to the scan order of the scan electrode Y.

Preferably, the scan driver 202 causes the width of scan pulse supplied to the first scan electrode among the plurality of scan electrodes Y upon scanning the scan electrode Y in the address period to be different from the width of scan pulse supplied to the second scan electrode having a different scan order from the first scan electrode, or causes the magnitude of the voltage of the scan pulse supplied to the first scan electrode among the plurality of scan electrodes Y upon scanning the scan electrode Y in the address period to be different from the magnitude of the voltage of the scan pulse supplied to the second scan electrode having a different scan order from the first scan electrode

The scan driver 202 adjusts the width of pulse and/or the magnitude of the voltage of the scan pulse according to the temperature of the plasma display panel 200.

Preferably, in case where the temperature of the plasma display panel 200 is a first temperature, the width of the scan pulse supplied to the scan electrode Y upon scanning the scan electrode Y is different from, in case where the temperature of the plasma display panel 200 is a second temperature different from the first temperature, the width of the scan pulse supplied to the scan electrode Y, or in case where the temperature of the plasma display panel 200 is the first temperature, the magnitude of the voltage of the scan pulse supplied to the scan electrode Y upon scanning the scan electrode Y is different from, in case where the temperature of the plasma display panel 200 is the second temperature different from the first temperature, the magnitude of the voltage of the scan pulse supplied to the scan electrode Y.

The sustain driver 203 operates alternately with the scan driver 202 during the sustain period to supply the sustain pulse SUS to the sustain electrode Z, and supply a predetermined bias voltage Vzb to the sustain electrode Z during the address period and/or the set down period.

The subfield mapping unit 204 maps and outputs the image data supplied from the exterior, for example, a half tone correction unit.

The data alignment unit 205 rearranges the data mapped by the subfield mapping unit 204 so that the data corresponds to each data electrode X of the plasma display panel.

The data driver 201 samples and latches the data realigned by the data alignment unit 205 according to the control of a timing controller not shown, and then supplies the data to the data electrode X. In particular, the data driver 201 supplies the data to the data electrode X corresponding to a scan type that the scan driver 202 scans the scan electrodes Y.

The function, operation, and feature of each component of the plasma display panel of the present invention will be apparent from the following description of a driving method of a plasma display apparatus of the present invention.

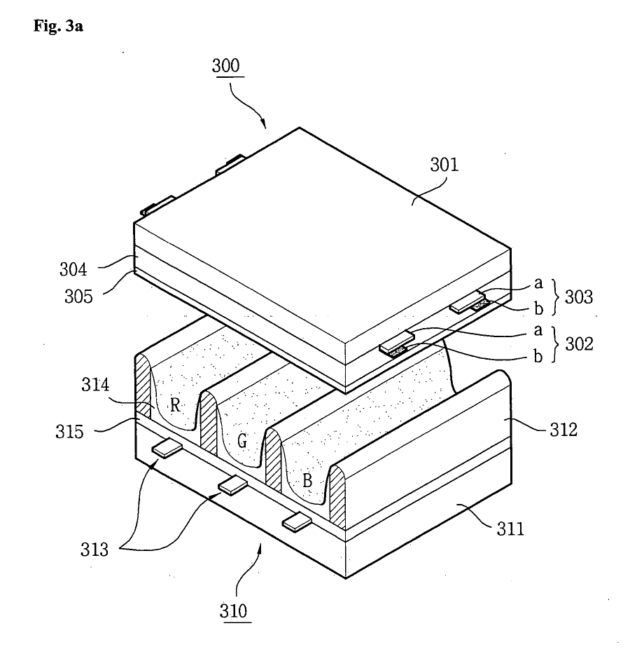

Hereafter, an embodiment of a plasma display panel 200 being a component of the plasma display apparatus of the present invention will be described in more detailed with reference to FIGS. 3a and 3b.

FIGS. 3a and 3b illustrate an embodiment of a plasma display panel structure according to the present invention.

Referring to FIG. 3a, in the plasma display panel, a front panel 300 arranged with a plurality of sustain electrodes formed from a pair of a scan electrode 302, Y and a sustain electrode 303, Z on a front substrate 301 being a display surface on which an image is displayed, and a rear panel 310 arranged with a plurality of data electrodes 313, X placed in the direction intersecting the plurality of sustain electrodes on a rear substrate 311 forming a rear surface are combined in parallel with each other with a predetermined distance in between.

The front panel 300 comprises a pair of the scan electrode 302, Y and sustain electrode 303, Z for causing a reciprocal discharge to occur and for sustaining the light emission of discharge cells, i.e. the scan electrode 302, Y and sustain electrode 303, Z being composed of a transparent electrode (a) formed of transparent ITO material and a bus electrode (b) made of metal material. The scan electrode 302, Y and sustain electrode 303, Z limits discharge current, and they are covered with one or more upper dielectric layers 304 serving as isolating between the pair of electrodes. A protective layer 305 deposited with MgO is formed on an upper surface of the upper dielectric layer 304 to facilitate discharge condition.

Stripe-type (or shell-type) barrier ribs 312 are arranged in parallel with one another on the rear panel 310 to form a plurality of discharge spaces, i.e. discharge cells. A plurality of data electrodes 313, X performing an address discharge to generate vacuum ultraviolet rays are arranged in parallel with the barrier ribs 312. R, G, and B phorphor bodies 314 which emit visible rays for an image display during the address discharge are formed on the upper side surface of the rear panel 310. A lower dielectric layer 315 is formed between the data electrode 313, X and the phosphor body 314 to protect the data electrode 313, X.

Although an embodiment of a plasma display panel being a component among the components of a plasma display apparatus of the present invention is described with reference to FIG. 3a, it will be understood that the present invention is not limited to the structure shown in FIG. 3a. For example, although FIG. 3a illustrates that the scan electrode 302, Y and sustain electrode 303, Z are formed on the front panel 300, and the data electrode X is formed on the rear panel 310, all of the scan electrode 302, Y, sustain electrode 303, Z and data electrode 313, X may also be formed on the front panel 300.

Although it is illustrated that the scan electrode 302, Y and sustain electrode 303, Z are composed of the transparent electrode (a) and bus electrode (b), respectively, one and more of the scan electrode 302, Y and sustain electrode 303, Z may be comprised of only the bus electrode (b).

FIG. 3b shows an arrangement structure in the plasma display panel having the same structure as that shown in FIG. 3a.

Referring to FIG. 3b, in the plasma display panel 300, the scan electrode Y and sustain electrode Z are formed in parallel with each other, and the data electrode X is formed such that it intersects the scan electrode Y and sustain electrode Z. Drivers are connected to these electrodes.

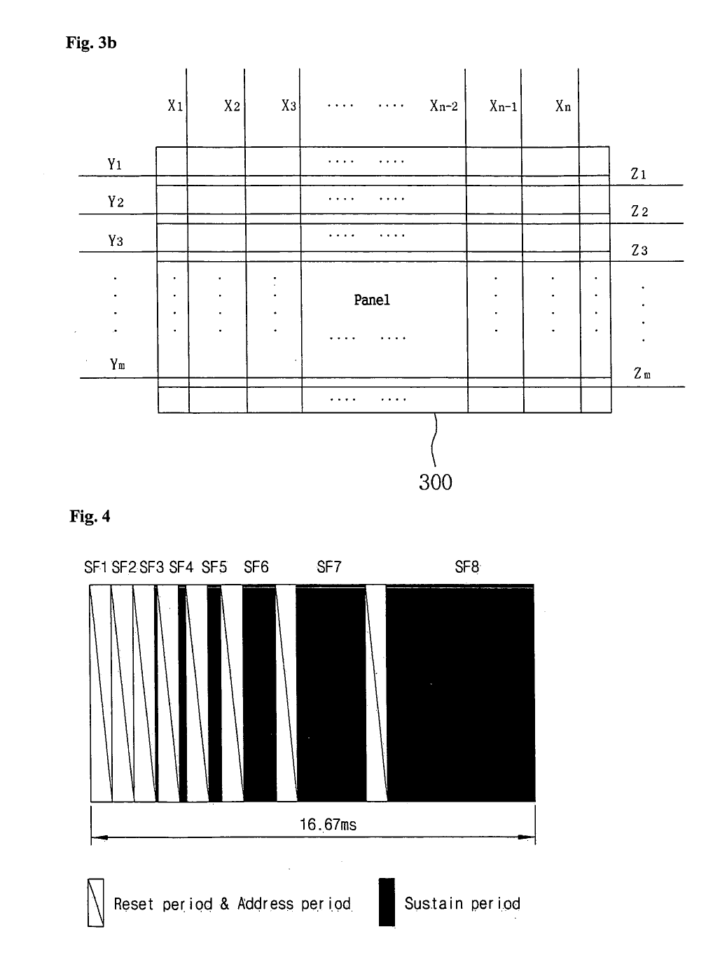

The plasma display apparatus of the present invention comprising the plasma display panel implements various image gray scales divided into a plurality of subfields. A method of implementing a gray scale in the plasma display apparatus of the present invention will be described with reference to FIG. 4.

FIG. 4 illustrates a method of implementing a gray scale of an image in a plasma display apparatus of the present invention.

Referring to FIG. 4, a method of implementing a gray scale in the plasma display apparatus of the present invention is completed by dividing a frame into a number of subfields what the number of light emissions for each subfield is different from each other, and again dividing the subfield into a reset period RPD for initializing all the discharge cells, an address period APD for selecting the discharge cell to be discharged, and a sustain period for implementing a gray scale according to the number of discharges.

For example, to display an image with 256 gray scales, a frame period (16.67 ms) corresponding to 1/60 sec is divided into, for example, 8 subfields SF1 to SF8 as shown in FIG. 4, and each of subfields SF1 to SF8 is again divided into a reset period, an address period and a sustain period.

The reset period and address period of each subfield is the same fore each subfield.

A data discharge for selecting the discharge cell to be discharged is generated by a voltage difference between the data electrode X and scan electrode Y.

The sustain period is a period for determining the weight value of a gray scale in each subfield. For example, the weight value of a gray scale in each subfield may be determined such that it is increased at the rate of 2ⁿ (wherein, n=0, 1, 2, 3, 4, 5, 6, 7) in such a way that the weight value of a first subfield is set to 20 and the weight value of a second subfield is set to 2¹ and the like. As such, various gray scales are implemented by adjusting the number of sustain pulses supplied in the sustain period of each subfield according to the weight value of gray scale in the sustain period of each subfield.

Although FIG. 4 illustrates where one frame is composed of 8 subfields, the number of subfields constituting one frame may be varied. For example, 12 subfields from a first subfield to a twelveth subfield may configure one frame, and as well 10 subfield may configure one frame.

Although FIG. 4 illustrates that the subfields are arranged in accordance to such an order that the weight value of gray scale is increased in one frame, the subfields may be arranged in accordance to such an order that the weight value of gray scale decreases in one frame, or the subfields may also be arranged regardless of the weight value.

The more detailed function and operation of the plasma display apparatus of the present invention will be apparent from the following description of a driving method of the plasma display apparatus of the present invention.

A driving method of a plasma display apparatus of the present invention will be described schematically. A driving method of a plasma display apparatus of the present invention scans the scan electrode Y with one of a plurality of scan types that orders of scanning a plurality of scan electrodes Y are different from one another in an address period. The driving method varies the width of pulse and/or magnitude of voltage of the scan pulse supplied to the scan electrode Y upon scanning the scan electrode Y.

In the driving method of the plasma display apparatus of the present invention, a method of scanning the scan electrode Y with one scan type among a plurality of scan types in which the order of scanning the plurality of scan electrodes is different from each other in an address period will be described.

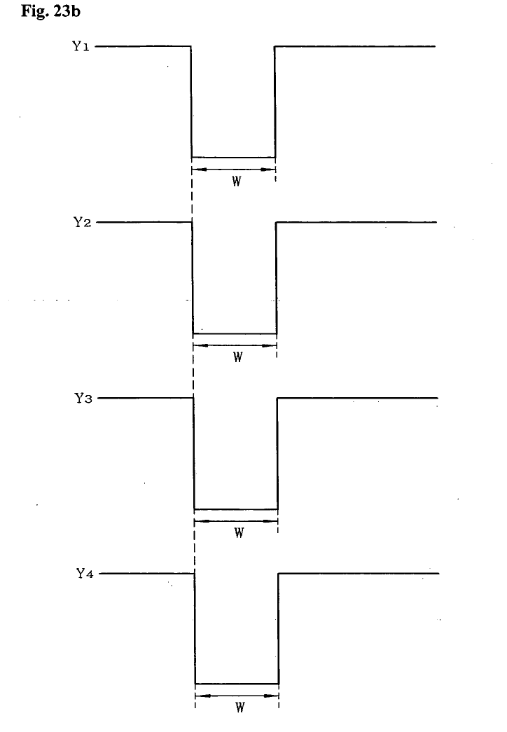

A primary feature of the present invention characterized by varying the width of pulse and/or magnitude of voltage of scan pulse supplied to the scan electrode Y upon scanning the scan electrode Y in the address period will be described later with reference to FIGS. 22 and so on.

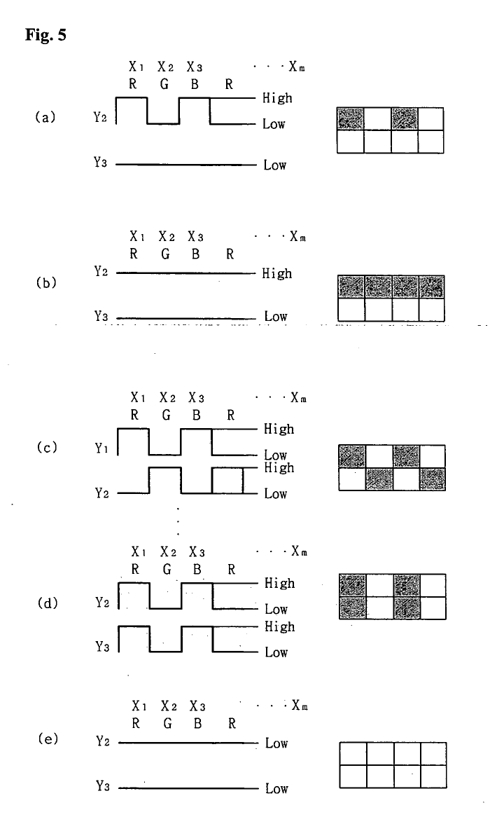

A primary factor determining one of a plurality of scan types is magnitude of displacement current according to an image data, which will be described with reference to FIG. 5.

FIG. 5 illustrates a magnitude of displacement current according to an inputted image data.

Referring to FIG. 5, image data in which logic values 1 (High) and 0 (Low) are represented by turns is applied to the data electrodes. For example, X1 to Xm data electrodes when the second electrode Y2 is scanned as shown in (a). In other words, the scan pulse is supplied to the second scan electrode Y2. In addition, when the third scan electrode Y3 is scanned, logic value 0 is sustained to the data electrode X. Logic value 1 is a state in which voltage of data pulse, i.e. data voltage Vd is applied to the corresponding data electrode X, and logic value 0 is a state in which 0V is applied to the corresponding data electrode, i.e. data voltage is not supplied.

In other words, the image data in which logic values 1 and 0 are alternated is applied to a discharge cell on one scan electrode Y, and the image data in which logic value 0 is sustained is applied to the discharge cell on subsequent scan electrode Y. The displacement current Id flowing in each data electrode X is as following equation 1.
Id=½(Cm1+Cm2)Vd, [Equation 1]
wherein

Id: displacement current flowing in each data electrode X

Cm1: equivalent capacitance between data electrodes X

Cm2: equivalent capacitance between data electrode X and scan electrode or between data electrode X and sustain electrode Z

Vd: voltage of data pulse applied to each data electrode X

When the second scan electrode Y2 is applied as shown in (b), the data electrodes X1 to Xm are applied with image data in which logic value 0 is sustained. When the third scan electrode Y3 is scanned, the data electrodes X1 to Xm are applied with image data in which logic value 0 is sustained. As mentioned above, logic value 0 is a state in which 0V is applied to the corresponding data electrode, i.e. data voltage is not supplied.

In other words, the image data in which logic value 1 is sustained is applied to a discharge cell on one scan electrode Y, and the image data in which logic value 0 is sustained is applied to the discharge cell on subsequent scan electrode Y. The image data in which logic value 0 is sustained is applied to a discharge cell on one scan electrode Y, and the image data in which logic value 1 is sustained is applied to the discharge cell on subsequent scan electrode Y.

The displacement current Id flowing in each data electrode X is as following equation 2.
Id=½(Cm2)Vd, [Equation 2]
wherein

Id: displacement current flowing in each data electrode X

Cm2: equivalent capacitance between data electrode X and scan electrode Y or between data electrode X and sustain electrode Z

Vd: voltage of data pulse applied to each data electrode X

When the second scan electrode Y2 is scanned as shown in (c), the image data in which logic values 1 and 0 are alternated is applied to the data electrodes X1 to Xm. When the third scan electrode Y3 is scanned, the image data in which logic values 1 and 0 are alternated is applied such that the difference from the phase of the image data applied to the discharge cell on the second scan electrode Y2 is 180°.

In other words, the image data in which logic values 1 and 0 are alternated is applied to discharge cell on one scan electrode Y, and the image data in which logic values 1 and 0 are alternated is applied to the discharge cell on subsequent scan electrode Y such that the difference from phase of image data applied to discharge cell on one scan electrode Y2 is 180°. The displacement current Id flowing in each data electrode X is as following equation 3.
Id=½(4Cm1+Cm2)Vd, [Equation 3]
wherein

Id: displacement current flowing in each data electrode

Cm2: equivalent capacitance between data electrode X and scan electrode Y or between data electrode X and sustain electrode Z

Vd: voltage applied to each data electrode

When the second scan electrode Y2 is scanned as shown in (d), the image data in which logic values 1 and 0 are alternated is applied to the data electrodes X1 to Xm. When the third scan electrode Y3 is scanned, the image data in which logic values 1 and 0 are alternated is applied such that its phase is the same as the phase of the image data applied to discharge cell on the second scan electrode Y2.

In other words, the image data in which logic values 1 and 0 are alternated is applied to the discharge cell on one scan electrode Y, and the image data in which logic values 1 and 0 are alternated is applied to the discharge cell on the subsequent scan electrode Y such that its phase is the same as the phase of image data applied to discharge cell on one scan electrode Y.

The displacement current Id flowing in each data electrode X is as following equation 4.
Id=0, [Equation 4]
wherein

Id: displacement current flowing in each data electrode X

Cm2: equivalent capacitance between data electrode X and scan electrode Y or between data electrode X and sustain electrode Z

Vd: voltage applied to each data electrode X

When the second scan electrode Y2 is applied as shown in (e), the data electrodes X1 to Xm are applied with image data in which the logic value 0 is sustained. When the third scan electrode Y3 is scanned, the third scan electrode Y3 is applied with the image data in which logic value 0 is sustained.

In other words, the image data in which logic value 0 is sustained is applied to the discharge cell on one scan electrode Y, and the image data in which logic value 0 is sustained is also applied to the discharge cell on the subsequent scan electrode Y.

The image data in which logic value 1 is sustained is applied to the discharge cell on one scan electrode Y, and the image data in which logic value 1 is sustained is applied to the discharge cell on the subsequent scan electrode Y.

The displacement current Id flowing in each data electrode X is as following equation 5.
Id=0, [Equation 5]
wherein

Id displacement current flowing in each data electrode X

Cm2: equivalent capacitance between data electrode X and scan electrode Y or between data electrode X and sustain electrode Z

Vd: voltage applied to each data electrode X

As shown in Equations 1 to 5, the largest displacement current flows where the image data in which logic values 1 and 0 are alternated is applied to the discharge cell on one scan electrode Y, and the image data in which logic values 1 and 0 are alternated is applied to the discharge cell on the subsequent scan electrode Y such that the difference between from phase of image data applied to discharge cell on one scan electrode Y is 180°.

The largest displacement current flows where the image data in which logic values 1 and 0 are alternated is applied to discharge cell on one scan electrode Y, and the image data in which logic values 1 and 0 are alternated is applied to the discharge cell on the subsequent scan electrode Y such that its phase is the same as phase of image data applied to discharge cell on one scan electrode Y, or case that the image data in which logic value 0 is sustained is applied to both the discharge cell on one scan electrode Y and the discharge cell on the subsequent scan electrode Y.

As shown in FIG. 5, the largest displacement current flows where the image data with different logic values is alternately supplied, and in this case the probilis of electrical damage to the data driver integrated circuit is highest.

In other words, in terms of the data driver integrated circuit responsible for one data electrode X, the image data as shown in (c) of FIG. 5 corresponds where the number of times the data driver integrated circuit switched is the highest. Therefore, as the number of times the data driver integrated circuit switched is increased, the displacement current flowing in the data driver integrated circuit also increases, and thus the probability of electrical damage to the data driver integrated circuit is higher.

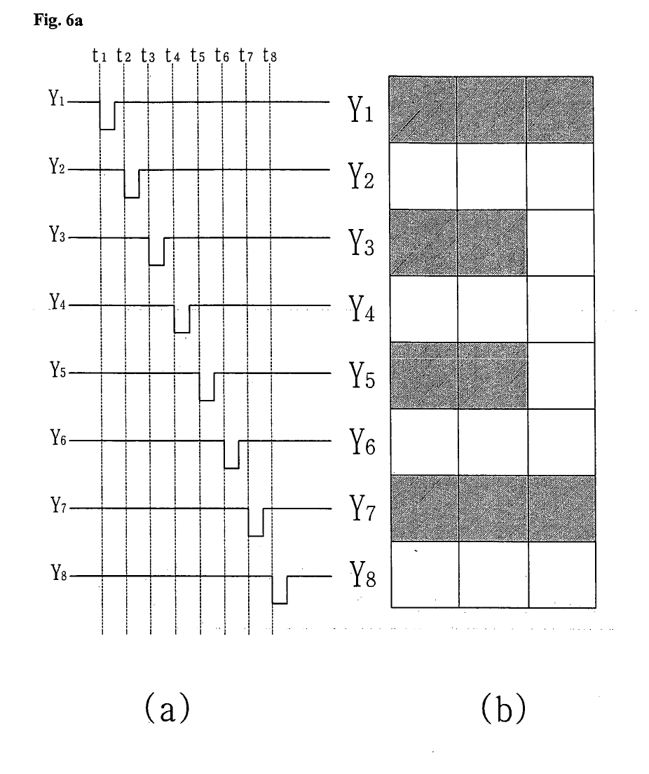

An embodiment of a method of changing the scan order considering the image data and the magnitude of the displacement current according to the image data will be described later with reference to FIGS. 6a and 6b.

FIGS. 6a and 6b illustrate an embodiment of a method of changing a scan order considering an image data and a displacement current according to the image data.

FIGS. 6a and 6b have the same image data. However, the scan order thereof, i.e. the scanning order is different for each example.

Referring to FIG. 6a, if the scan electrodes Y are scanned in such a scan order as shown in (a), where the image data is supplied as shown in (b), then the frequency of changing the logic values of the image data in the direction of array of the scan electrodes Y is relatively height, and thus a relatively high displacement current is generated.

If the scanning order of the scan electrodes Y in the image data pattern is readjusted as shown in (a) of FIG. 6b, then the image data is arranged as shown in (b) of FIG. 6b. Thus, the frequency of changing the logic values of the image data in the direction of array of scan electrodes Y is decreases, and thus the displacement current generated is also decreases.

If the scanning order of the scan electrodes Y is adjusted according to the image data as shown in FIG. 6b, then the displacement current flowing in the data driver integrated circuit is decreases, and thus the possibility of electrical damage to the data driver integrated circuit decreases.

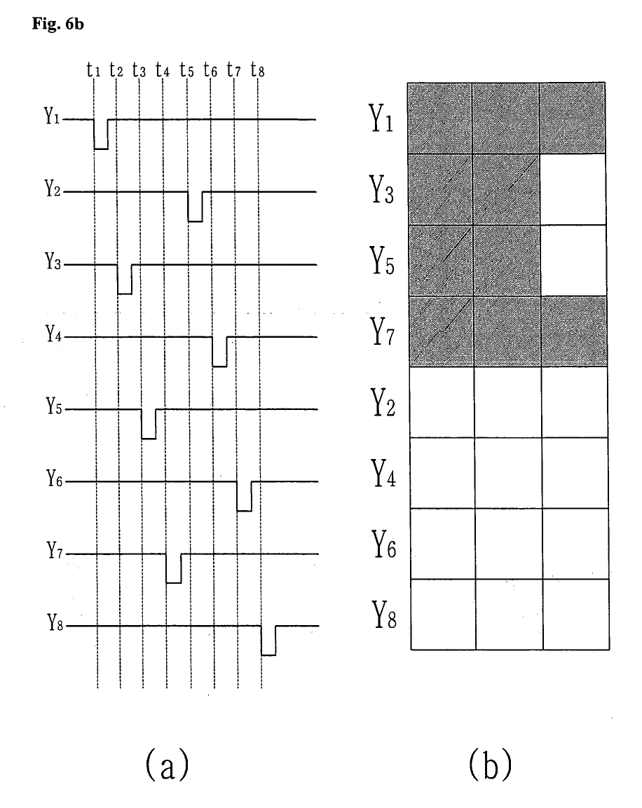

The driving method of the plasma display panel of the present invention is invented in view of the principle of FIGS. 6a and 6b, another embodiment of a driving method of a plasma display panel of the present invention will be described with reference to FIG. 7.

FIG. 7 illustrates another embodiment in a driving method of a plasma display apparatus of the present invention.

Referring to FIG. 7, a driving method of a plasma display panel according to the present invention can perform scanning with one scan type selected from total 4 scan types, i.e. a first type Type 1, a second type Type 2, a third type Type 3, and a fourth type Type 4 as shown in FIG. 7.

In the scan order of the first scan type Type 1, the scanning is performed in the order that the scan electrodes Y are arranged as Y1-Y2-Y3- . . . .

In the scan order of the second scan type Type 2, the scan electrodes Y included in a first group are sequentially scanned, and the scan electrodes Y included in a second group are sequentially scanned. In other words, the scan electrodes Y1-Y3-Y5- . . . Yn−1 are scanned, and the scan electrodes Y2-Y4-Y6- . . . Yn are scanned.

In the scan order of the third scan type Type 3, the scan electrodes Y included in the first group are sequentially scanned, the scan electrodes Y included in the second group are sequentially scanned, and then the scan electrodes Y included in the third group are sequentially scanned. In other words, the scan electrodes Y1-Y4-Y7- . . . Yn−2 are scanned, the scan electrodes Y2-Y5-Y8- . . . Yn−1 are scanned, and then the scan electrodes Y3-Y6-Y9- . . . Yn are scanned.

In the scan order of the fourth scan type Type 4, the scan electrodes Y included in the first group are sequentially scanned, the scan electrodes Y included in the second group are sequentially scanned, the scan electrodes Y included in the third group are sequentially scanned, and then the scan electrodes Y included in the fourth group are sequentially scanned. In other words, the scan electrodes Y1-Y5-Y9- . . . Yn−3 are scanned, the scan electrodes Y2-Y6-Y10- . . . Yn−2 are scanned, the scan electrodes Y3-Y7-Y11- . . . Yn−1 are scanned, and then the scan electrodes Y4-Y8-Y12- . . . Yn are scanned.

Although FIG.7 illustrates the method in which the total 4 scan types are provided and the scan electrodes Y are scanned with one scan type selected from the 4 scan types, many other scan types including 2 scan types, 3 scan types, 5 scan types, etc. can be provided and the scan electrodes Y can be scanned with one scan type selected from the scan types.

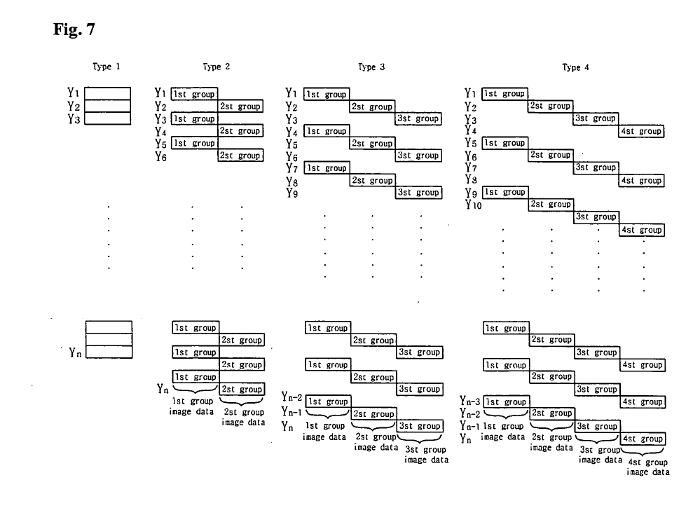

The scan driver 202 as indicated by reference number 202 in FIG. 2 in which a plurality of scan types are provided and the scan electrodes Y are scanned with one of the plurality of scan types will be described in more detailed with reference to FIG. 8.

FIG. 8 is a detailed view for illustrating a configuration and an operation of a scan driver for implementing a driving method of a plasma display apparatus of the present invention.

Referring to FIG. 8, the scan driver for implementing a driving method of a plasma display apparatus according to the present invention may comprise a data determination unit 1000 and a scan order determination unit 1001.

The data determination unit 1000 receives the image data mapped by the subfield mapping unit 204, compares the image data of a bundle of cells composed of one and more discharge cells located on the line of the specific scan electrode Y with the image data of the bundle of cells located in the vertical and horizontal direction of the bundle of cells according to each of the plurality of scan types, and then calculates the displacement current.

The bundle of cells refer to one unit which is composed of one and more cells. For example, a pixel is a bundle of cells since cells corresponding to R, G, and B are collected and constitutes one pixel.

The scan order determination determines the scan order according to the scan type having a lowest displacement current using the information about magnitude of displacement current calculated by the data determination unit 1000.

The information about the scan order determined by the scan order determination unit 1001 is applied to the data alignment unit 205 which rearranges the image data subfield-mapped by the subfield mapping unit 1204 according to the scan order determined by the scan order determination unit 1001 and supplies the rearranged image data to the data electrode X.

The construction of the scan electrode unit 202 in FIG. 8 will be described in association with the embodiment of FIG. 7. If the data comparison unit 1000 in FIG. 8 calculates the magnitude of the displacement current for 4 scan types in FIG. 7 and applies the information of the magnitude of the displacement current for 4 scan types to the scan order determination unit 1001, then the scan order determination unit 1001 compares the magnitude of each displacement current for the above 4 scan types to thereby select one scan type having the lowest displacement current. For example, assuming that the magnitude of the displacement current for the first, second, third, and fourth scan types is 10, 15, 11 and 8, respectively, the scan order determination unit 1001 selects the fourth scan type and determines the scanning order of the scan electrodes Y according to the fourth scan type.

Assuming that the magnitude of the displacement current for all the scan types except for the second scan type among the total 4 scan types, i.e. the first, third, and fourth scan types is low enough not to cause an electrical damage to the data driver integrated circuit, the scan order determination unit 1001 can select any scan type of the first, third and fourth scan types.

The information for a current low enough not to cause an electrical damage to the data driver integrated circuit may be predefined. In other words, the maximum value of current low enough not to cause an electrical damage to the data driver integrated circuit may be predefined as a threshold current, and the scan type that the current below the threshold current is generated may be selected.

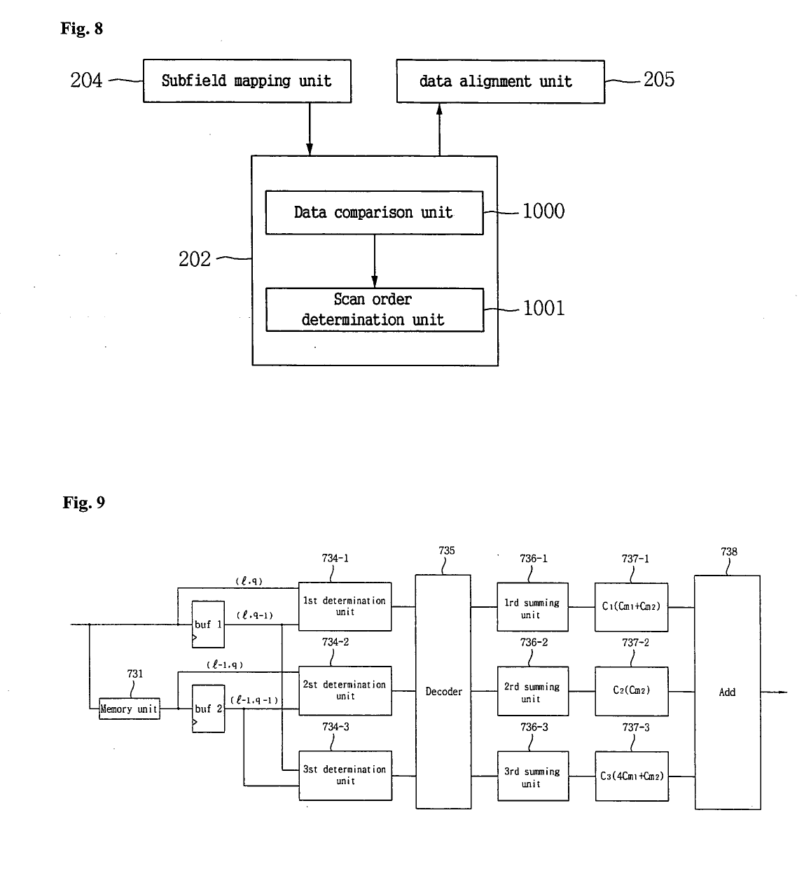

The data comparison unit as indicated by reference number 1000 in FIG. 8 will be described in more detailed with reference to FIG. 9.

FIG. 9 is a block diagram of a basic circuit included in a data comparison unit 1000 included in a scan driver of a plasma display apparatus of the present invention.

As shown in FIG. 9, a basic circuit block included in the data comparison unit 1000 of the scan driver in the plasma display apparatus of the present invention comprises a memory unit 731, a first buffer buf1, a second buffer buf2, a first to third determination unit 734-1, 734-2, 734-3, a decoder unit 735, a first to third summing unit 736-1, 736-2, 736-3, a first to third current calculation unit 737-1, 737-2, 737-3 and a current summing unit 738.

Image data corresponding to l−1th scan electrode, i.e. l−1th scan electrode line is stored in the memory unit 731, and an image corresponding to lth scan electrode, i.e. lth scan electrode line is input.

The first buffer buf1 temporarily stores image data of the q−1th discharge cell among the discharge cells corresponding to the lth scan electrode line.

The second buffer buf2 temporarily stores image data of the q−1th discharge cell among the discharge cells corresponding to the l−1th scan electrode line stored in the memory unit 731.

The first determination unit 734-1 compares the image data of the qth discharge cell of the lth scan electrode line including an exclusive OR gate with the image data of q−1th discharge cell of the lth scan electrode line stored in the first buf1, and if both image data are not the same, 1 is output, but if otherwise, 0 is output.

The second determination unit 734-2 compares the image data of the qth discharge cell of the l−1th scan electrode line including an exclusive OR gate with the image data of q−1th discharge cell of the l−1th scan electrode line stored in the second buffer buf2, and if both the image data is not the same, 1 is output, but if otherwise, 0 is output.

The third determination unit 734-3 compares the image data of the q−1th discharge cell of the lth scan electrode line stored in the first buffer buf1 including an exclusive OR gate with the image data of q−1th discharge cell of the l−1th scan electrode line stored in the second buffer buf2, and if both image data is not the same, 1 is output, but if otherwise, 0 is output.

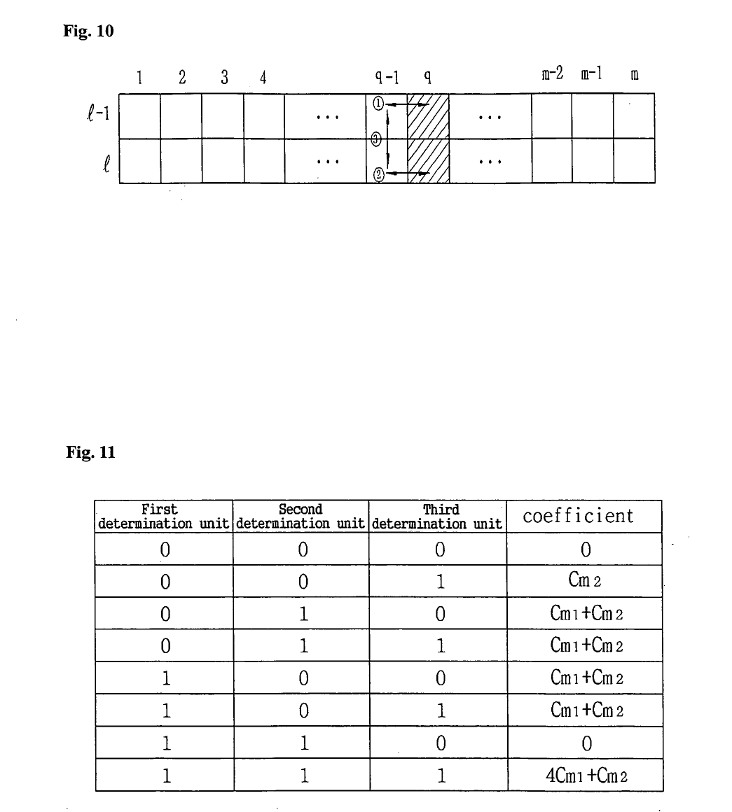

The operation of the first to third determination unit included in the basic circuit block of the data determination unit 1000 having the above configuration will be described in more detailed with reference to FIG. 10.

FIG. 10 is a detailed view for illustrating the operation of a first to a third determination units of a data comparison unit. Each of \textcircled{1} \textcircled{2} and \textcircled{3} corresponds to the first determination unit 734-1, the second determination unit 734-2, and the third determination unit 734-3.

Referring to FIG. 10, the data determination unit 1000 of the present invention compares the image data of adjacent cells located in the horizontal and vertical directions of one cell through the first determination unit 734-1 to the third determination unit 734-3 to thereby determine the variation.

The decoder 735 outputs a 3 bit output signal corresponding to the output signal of each of the first determination unit to third determination unit 734-1, 734-2 734-3.

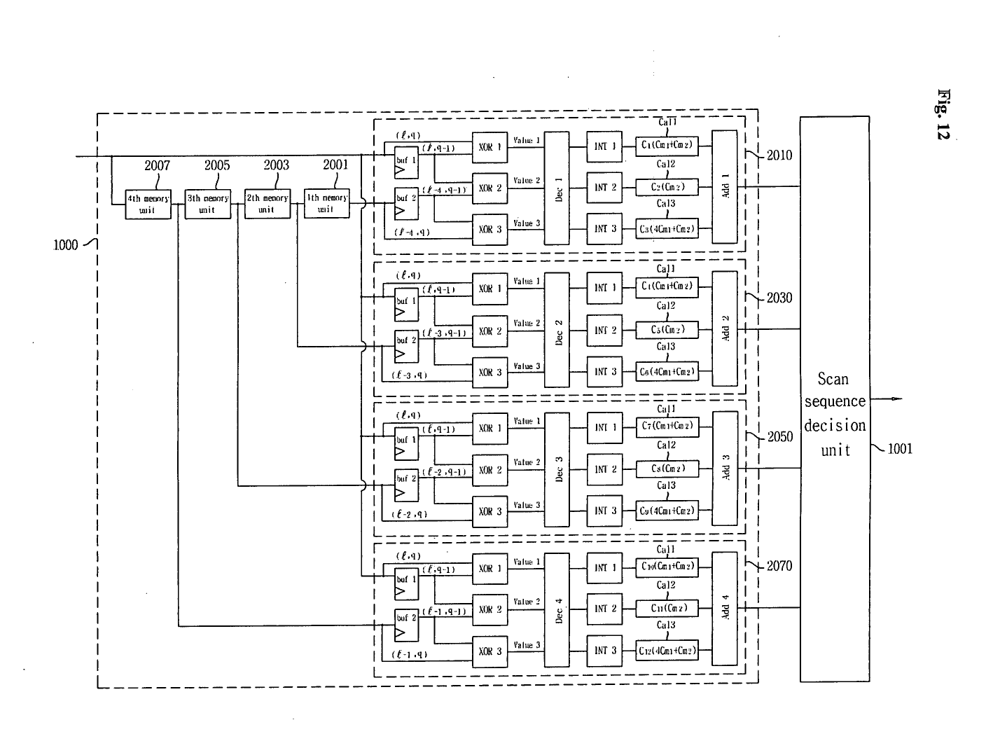

FIG. 11 illustrates a pattern of an image data according to an outputted signal of a first to a third determination units 734-1, 734-2, 734-3 included in a basic circuit block of a data comparison unit of the present invention.

Referring to FIG. 11, where the output signal of each of the first determination unit to third determination unit 734-1, 734-2, 734-3 is (0,0,0), then it is the same as the image data pattern shown in (e) of FIG. 5. Accordingly, if the output signal is (0,0,0), the displacement current Id is 0.

Where the output signal of each of the first determination unit to third determination unit 734-1, 734-2, 734-3 is (0,0,1), then it is the same as the image data pattern shown in (b) of FIG. 5. Accordingly, if the output signal is (0,0,1), the displacement current Id is in proportion to Cm2.

Where the output signal of each of the first determination unit to third determination unit 734-1, 734-2, 734-3 is any one of (0,1,0), (0,1,1), (1,0,0) and (1,0,1), then it is the same as the image data pattern shown in (a) of FIG. 5. Accordingly, if the output signal is any one of (0,1,0), (0,1,1), (1,0,0) and (1,0,1), the displacement current Id is in proportion to (Cm1+Cm2).

Where the output signal of each of the first determination unit to third determination unit 734-1, 734-2, 734-3 is (1,1,0), then it is the same as the image data pattern shown in (d) of FIG. 5. Accordingly, if the output signal is (1,1,0), the displacement current Id is 0.

Where the output signal of each of the first determination unit to third determination unit 734-1, 734-2, 734-3 is (1,1,1), then it is the same as the image data pattern shown in (c) of FIG. 5. Accordingly, if the output signal is (1,1,1), the displacement current Id is in proportion to (4Cm1+Cm2).

The first to third summing units 736-1, 736-2, 736-3 sum and output the output frequency of the specific 3 bit output signal outputted from the decoder 735.

In other words, the first summing unit 736-1 sums the output frequency of any one of (0,1,0), (0,1,1), (1,0,0) and (1,0,1) outputted by the decoder(735). The second summing unit (736-2) sums(C2) the output frequency of (0,0,1) outputted by the decoder 735. The third summing unit (736-3) sums(C3) the output frequency of (1,1,1) outputted by the decoder 735.

Each of the first to the third current calculation unit 737-1, 737-2 737-3 receives C1, C2 and C3 from the first to third summing unit 736-1, 736-2 736-3 and calculates the magnitude of the displacement current.

The current summing unit 738 sums the magnitude of the displacement current calculated from each of the first to third current calculation unit 737-1, 737-2 737-3.

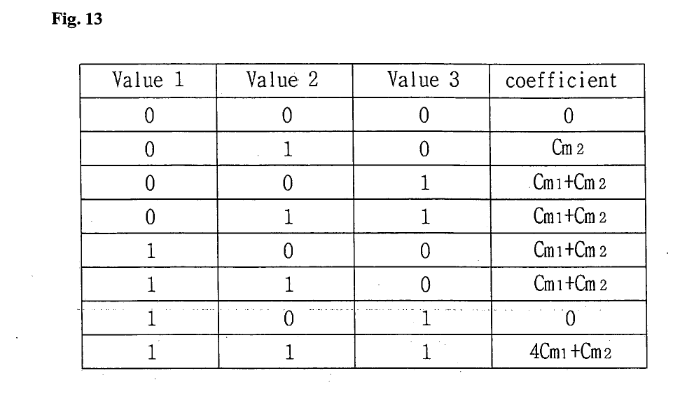

FIG. 12 is a block diagram of data comparison unit 1000 and a scan order determination unit 1001 of a scan driver in a plasma display apparatus of the present invention.

As shown in FIG. 12, the data comparison unit 1000 of the scan driver in the plasma display apparatus of the present invention has a configuration in which the 4 basic blocks shown in FIG. 12 are connected to one another, and the scan order determination unit 1001 compares the outputs of 4 basic blocks and determines the scan order which causes the lowest displacement current to be generated. In the embodiment of FIG. 12, the scan type has a total 4 scan types as the embodiment of FIG. 7. In other words, it should be noted that the embodiment is described in which the data comparison unit 1000 and scan order determination unit 1001 has the configuration in which the scan electrodes Y are scanned by one of the total 4 scan types.

The data comparison unit 1000 comprises a first to a fourth memory unit 2001, 2003, 2005 2007 and a first to a fourth current determination unit 2010, 2030, 2050 2070. In other words, one memory unit and one current determination unit correspond to the basic circuit block shown in FIG. 12.

The first to fourth memory unit 2001, 2003, 2005 2007 are serially connected to one another, and thus the image data corresponding to 4 scan electrode lines is stored. In other words, the first memory unit 2001, second memory unit 2003, third memory unit 2005 and fourth memory unit 907 store the image data corresponding to the l−4th scan electrode line, the l−3th scan electrode line, l−2th scan electrode line and l−1th scan electrode line, respectively.

The first current determination 2010 receives the image data of the lth scan electrode Y line and l−4th scan electrode Y line stored in the first memory unit 2001. If the magnitude of the current of the first current determination unit 2010 receiving the image data is less than the current of the second to fourth current determination units 2030, 2050 and 2070, then the scan order is the same as the fourth scan type Type 4 in FIG. 7. In other words, the scan order should be in the order as Y1-Y5-Y9- . . . , Y2-Y6-Y10- . . . , Y3-7-Y11- . . . , and Y4-Y8-Y12- . . . .

The operation of the first current determination unit 2010 is the same as that of the basic circuit block described above. The image data corresponding to the l−4^{th} scan electrode Y line is stored in the first memory unit 2001, and the image data corresponding to the lth scan electrode Y line is input.

The first buffer buf1 temporarily stores image data of the q−1th discharge cell among the discharge cells corresponding to lth scan electrode line.

The second buffer buf2 temporarily stores an image data of q−1th discharge cell among discharge cells corresponding to l−1th scan electrode Y line stored in the first memory unit 2001.

The first determination unit XOR1 compares the image data l, q of qth discharge cell of the lth scan electrode line including an exclusive OR gate with the image data l, q−1 of q−1th discharge cell of the lth scan electrode line stored in the first buffer buf1, and if both image data are not the same, Value=1 is output, but if otherwise, Value=0 is output.

The second determination unit XOR2 compares the image data l, q−1 of q−1th discharge cell of the lth scan electrode Y line including an exclusive OR gate with the image data l−4, q−1 of q−1th discharge cell of the l−4th scan electrode Y line stored in the second buffer buf2, and if both image data are not the same, Value=1 is output, but if otherwise, Value=0 is output.

The third determination unit XOR3 compares the image data l−4, q−1 of q−1th discharge cell of the l−4th scan electrode Y line including an exclusive OR gate with the image data l−4, q of qth discharge cell of the l−4th scan electrode Y line outputted from the memory unit 901, and if both image data are not the same, Value=1 is output, but if otherwise, Value=0 is output.

The first decoder Dec1 parallelly receives the output signal of each of the first to third determination units XOR1, XOR2 XOR3 and outputs the 3 bit output signal.

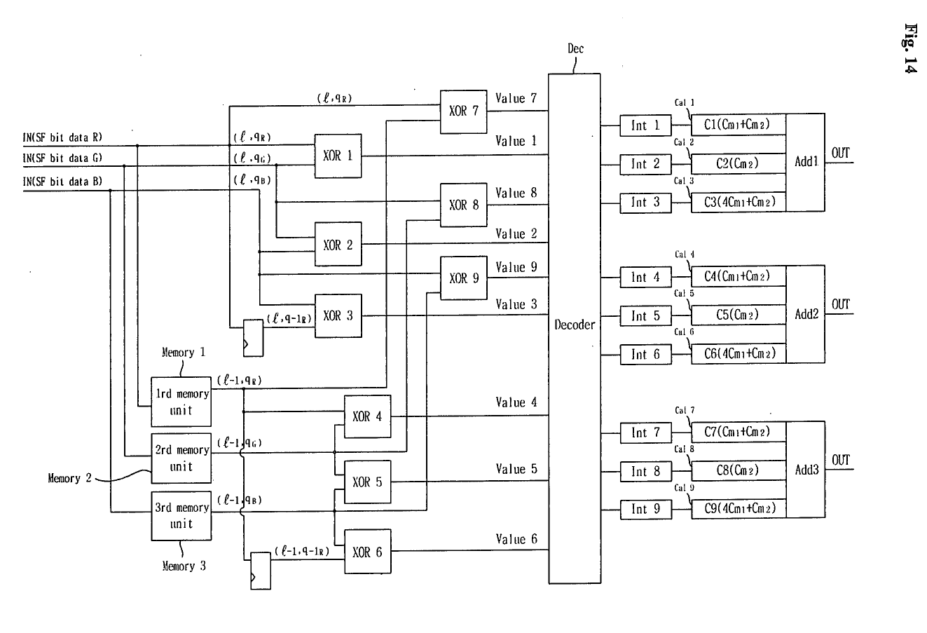

FIG. 13 illustrates a pattern of image data according to an output signal of a first to a third determination unit XOR1, XOR2 and XOR3 included in a data comparison unit of the present invention.

Referring to FIG. 13, the magnitude of the capacitance determining the magnitude of the displacement current is changed depending on the output signal Value1, Value2 and Value3 of the first to third determination units XOR1, XOR2 and XOR3.

The first to third summing unit Int1, Int2 Int3 sum and output the output frequency of the specific 3 bit output signal outputted from the decoder Dec1.

In other words, the first summing unit Int1 sums C1 the output frequency of any one of (0,0,1), (0,1,1), (1,0,0) and (1,1,0) outputted by the first decoder Dec1. The second summing unit Int2 sums C2 the output frequency of (0,1,0) outputted by the first decoder Dec1. The third summing unit Int3 sums C3 the output frequency of (1,1,1) outputted by the first decoder Dec1.

Each of the first to the third current calculation unit Cal1, Cal2 and Cal3 receives C1, C2 and C3 from the first to third summing unit Int1, Int2 and Int3 and calculates the magnitude of the displacement current.

In other words, the first current calculation unit Cal1 calculates the magnitude of the current by multiplying the output of the first summing unit Int1 and (Cm1+Cm2). The second current calculation unit Cal2 calculates the magnitude of the current by multiplying the output C2 of the second summing unit Int2 and Cm2. The third current calculation unit Cal3 calculates the magnitude of the current by multiplying the output C3 of the third summing unit Int3 and (4Cm1+Cm2).

The first current summing unit Add1 sums the magnitude of the displacement current calculated from each of the first to the third current calculation unit Cal1, Cal2 and Cal3.

The second to the fourth current determination units 2030, 2050 and 2070 also calculate the summed displacement current by the same operation as that of the first current determination unit.

The first determination unit XOR1 of the second current determination unit 2030 compares the image data l, q of qth discharge cell of the Ith scan electrode Y line including an exclusive OR gate with the image data l, q−1 of q−1th discharge cell of the lth scan electrode line stored in the first buffer buf1, and if both image data are not the same, 1 is output, but if otherwise, 0 is output.

The second determination unit XOR2 of the second determination unit 2030 compares the image data l, q−1 of q−1th discharge cell of the lth scan electrode Y line including an exclusive OR gate with the image data l−3, q−1 of q−1th discharge cell of the l−3th scan electrode Y line stored in the second buffer buf2, and if both image data are not the same, 1 is output, but if otherwise, 0 is output.

The third determination unit XOR3 compares the image data l−3, q−1 of q−1th discharge cell of the l−3th scan electrode Y line stored in the second buffer buf2 including an exclusive OR gate with the image data l−3, q of qth discharge cell of the l−3th scan electrode Y line outputted from the second memory unit 2003, and if both image data are not the same, 1 is output, but if otherwise, 0 is output.

The first determination unit XOR1 of the third current determination unit 2050 compares the image data l, q of qth discharge cell of the lth scan electrode Y line including an exclusive OR gate with the image data l, q−1 of q−1th discharge cell of the lth scan electrode line stored in the first buffer buf1, and if both image data is not the same, 1 are output, but if otherwise, 0 is output.

The second determination unit XOR2 of the third determination unit 2050 compares the image data l, q−1 of q−1th discharge cell of the lth scan electrode Y line including an exclusive OR gate with the image data l−2, q−1 of q−1th discharge cell of the l−2th scan electrode Y line stored in the second buffer buf2, and if both image data is not the same, 1 is outputted, but if otherwise, 0 is outputted.

The third determination unit XOR3 of the third current determination 2050 compares the image data l−2, q−1 of q−1th discharge cell of the l−2th scan electrode Y line stored in the second buffer buf2 including an exclusive OR gate with the image data l−2, q of qth discharge cell of the l−2th scan electrode Y line outputted from the third memory unit 2005, and if both image data are not the same, 1 is output, but if otherwise, 0 is output.

The first determination unit XOR1 of the fourth current determination unit 2070 compares the image data l, q of qth discharge cell of the lth scan electrode Y line including an exclusive OR gate with the image data l, q−1 of q−1th discharge cell of the lth scan electrode line stored in the first buffer buf1, and if both image data are not the same, 1 is output, but if otherwise, 0 is output.

The second determination unit XOR2 of the fourth determination unit 2070 compares the image data l, q−1 of q−1th discharge cell of the lth scan electrode Y line including an exclusive OR gate with the image data l−1, q−1 of q−1th discharge cell of the l−1th scan electrode Y line stored in the second buffer buf2, and if both image data are not the same, 1 is output, but if otherwise, 0 is output.

The third determination unit XOR3 of the fourth current determination 2070 compares the image data l−1, q−1 of q−1th discharge cell of the l−1th scan electrode Y line stored in the second buffer buf2 including an exclusive OR gate with the image data l−1, q of qth discharge cell of the l−1th scan electrode Y line outputted from the fourth memory unit 2007, and if both image data are not the same, 1 is output, but if otherwise, 0 is output.

The scan order determination unit 1001 receives the magnitude of the displacement current calculated by each of the first to the fourth current determination unit 2010, 2030, 2050 the 2070 and determines the scan order according to the current determination units having outputted the lowest displacement current thereof. The scan order is determined according to the any one of scan types in which the displacement current below the predetermined threshold current is generated.

For example, if the scan order determination unit 1001 determines the displacement current received from the second current determination unit 2030 is the lowest, then it 1001 causes the scan order to be the same as the third scan type Type 3 in FIG. 9, i.e. in the order as Y1-Y4-Y7- . . . , Y2-Y5-Y8- . . . , and Y3-Y6-Y9- . . . .

For example, if the scan order determination unit 1001 determines the displacement current received from the third current determination unit 2050 is the lowest, then it 1001 causes the scan order to be the same as the second scan type Type 2 in FIG. 9, i.e. in the order as Y1-Y3-Y5- . . . , and Y2-Y4-Y6- . . . .

If the scan order determination unit 1001 determines the displacement current received from the fourth current determination unit 2070 is the lowest, then it 1001 causes the scan order to be the same as the first scan type Type 1 in FIG. 9, i.e. in the order as Y1-Y2-Y3-Y4-Y5-Y6- . . . .

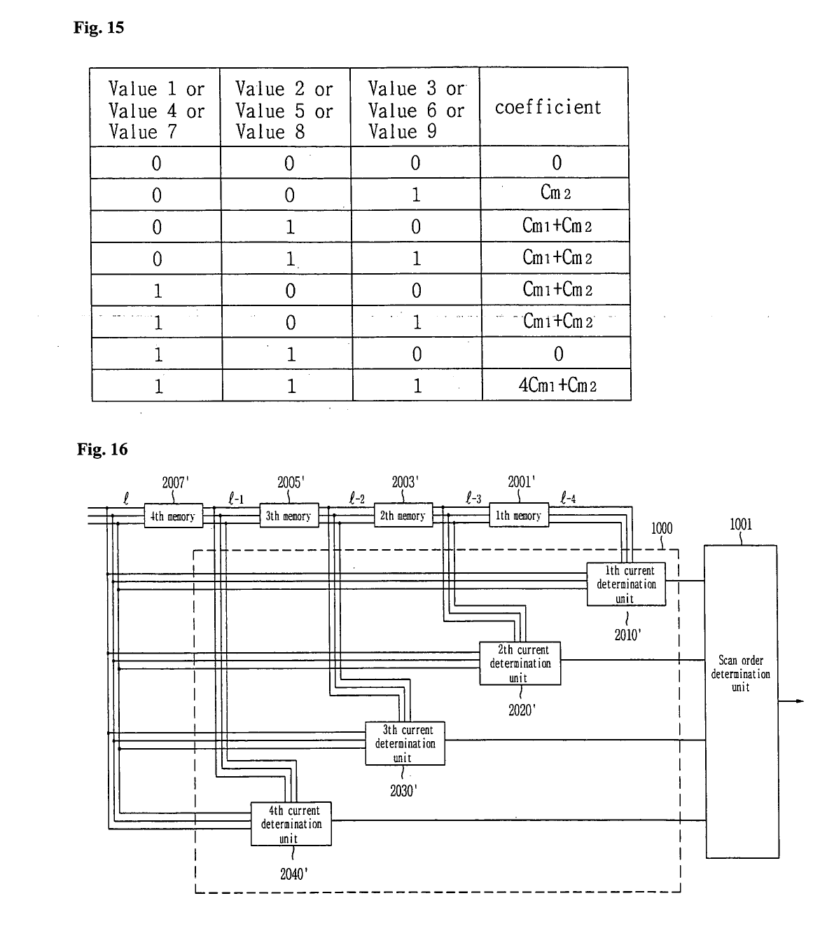

The basic circuit block included in the data comparison unit 1000 of the scan driver in the plasma display apparatus of the present invention illustrated in FIG. 9 can be configured in a different manner from FIG. 9, which will be described with reference to FIG. 14.

FIG. 14 is another block diagram of a basic circuit included in a data comparison unit 1000 included in a scan driver of a plasma display apparatus of the present invention.

Referring to FIG. 14, the basic circuit block in FIG. 14 calculates the magnitude of the displacement current through the variation of the image data corresponding to the R, G, B cells of the qth and q−1th pixels on the lth scan electrode line, the variation of the image data corresponding to the R, G, B cells of the qth and q−1th pixels on the l−1th scan electrode line, and the variation of the image data corresponding to the R, G, B cells of the qth pixel on the lth scan electrode line and the q−1th pixel on the l−1 the scan electrode line.

The first to the third memory units Memory1, Memory2 and Memory3 temporarily store the image data corresponding to the R, G, B cells of the l−1th scan electrode line, respectively.

The first to third determination unit XOR1, XOR2 and XOR3 determine the variation between the image data corresponding to the R, G, B cells of the qth pixels on the lth scan electrode line.

In other words, the first determination unit XOR1 compares the image data l, qB corresponding to R cell of the qth pixel on the lth scan electrode line with the image data l, qG corresponding to the G cell of the qth pixel on the lth scan electrode line, and if both image data are the same, logic value 1 is output, but if otherwise, logic value 0 is output.

The second determination unit XOR2 compares the image data l, qB corresponding to G cell of the qth pixel on the lth scan electrode line with the image data l, qB corresponding to B cell of the qth pixel on the lth scan electrode line, and if both image data are the same, logic value 1 is output, but if otherwise, logic value 0 is output.

The third determination unit XOR3 compares the image data l, qR corresponding to B cell of the qth pixel on the lth scan electrode line with the image data l, q−1R corresponding to R cell of the q−1th pixel on the lth scan electrode line, and if both image data are the same, logic value 1 is output, but if otherwise, logic value 0 is output.

The fourth to sixth determination units XOR4, XOR5 and XOR6 determine the variation between the image data corresponding to R, G, B cells of the qth pixels on the l−1th scan electrode line.

In other words, the fourth determination unit XOR4 compares the image data l−1, qR corresponding to the R cell of the qth pixel on the l−1th scan electrode line with the image data l−1, qG corresponding to G cell of the qth pixel on the l−1th scan electrode line, and if both image data are the same, logic value 1 is output, but if otherwise, logic value 0 is output.

The fifth determination unit XOR5 compares the image data l−1, qG corresponding to G cell of the qth pixel on the l−1th scan electrode line with the image data l−1, qB corresponding to B cell of the qth pixel on the l−1th scan electrode line, and if both image data are the same, logic value 1 is output, but if otherwise, logic value 0 is output.

The sixth determination unit XOR6 compares the image data l−1, qB corresponding to B cell of the qth pixel on the l−1th scan electrode line with the image data l−1, q−1R corresponding to R cell of the q−1th pixel on the l−1th scan electrode line, and if both image data are the same, logic value 1 is output, but if otherwise, logic value 0 is output.

The seventh to ninth determination units XOR7, XOR8 and XOR9 compare each of the image data corresponding to the R, G and B cells of the qth pixels on the lth scan electrode line with each of the image data corresponding to the R, G and B cells of the qth pixels on the l−1 the scan electrode line and determine the variations between the image data.

In other words, the seventh determination unit XOR7 compares the image data l, qR corresponding to R cell of the qth pixel on the lth scan electrode line with the image data l−1, qR corresponding to the R cell of the qth pixel on the l−1th scan electrode line, and if both image data are the same, logic value 1 is output, but if otherwise, logic value 0 is output.

The eighth determination unit XOR8 compares the image data l, qG corresponding to the G cell of the qth pixel on the lth scan electrode line with the image data l−1, qG corresponding to the G cell of the qth pixel on the l−1th scan electrode line, and if both image data are the same, logic value 1 is output, but if otherwise, logic value 0 is output.

The ninth determination unit XOR9 compares the image data l, qB corresponding to the B cell of the qth pixel on the lth scan electrode line with the image data l−1, qB corresponding to the B cell of the qth pixel on the l−1th scan electrode line, and if both image data are the same, logic value 1 is output, but if otherwise, logic value 0 is output.

The decoder Dec outputs 3 bit signal corresponding to the output signals Value1, Value2 and Value3 of each of the first to the third determination unit XOR1, XOR2 and XOR3, the output signals Value4, Value5 and Value6 of each of the fourth to sixth determination units XOR4, XOR5 and XOR6, and the output signals Value7, Value8 and Value9 of each of the seventh to the ninth determination unit XOR7, XOR8 and XOR9.

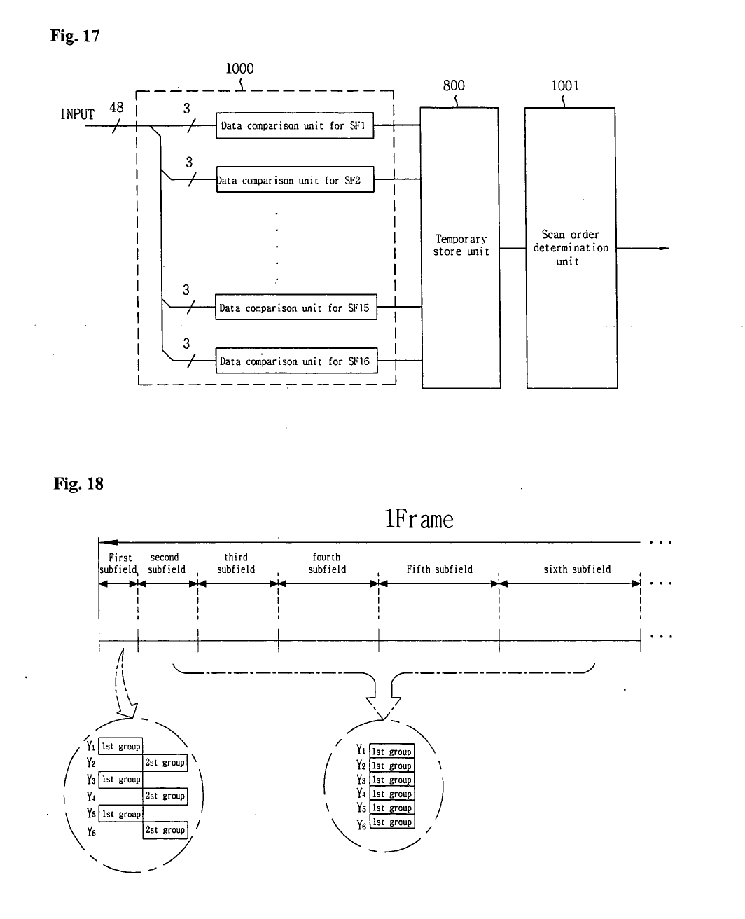

FIG. 15 illustrates a pattern of an image data according to an output signal of a first to a ninth determination unit XOR1˜XOR9 included in the circuit block of FIG. 14 of the present invention.

Referring to FIG. 15, each of the first to third summing units Int1, Int2 and Int3 sum and output the output frequency of 3 bit output signal corresponding to the output signals Value1, Value2 and Value3 of the first to third determination units XOR1, XOR2 and XOR3 from the decoder Dec.

Each of the fourth to sixth summing units Int4, Int5 and Int6 sum and output the output frequency of 3 bit output signal corresponding to the output signals Value4, Value5 and Value6 of the fourth to the sixth determination units XOR4, XOR5 and XOR6 from the decoder Dec.

Each of the seventh to the ninth summing unit Int7, Int8 and Int9 sum C7, C8 and C9 and output the output frequency of 3 bit output signal corresponding to the output signals Value7, Value8 and Value9 of the seventh to the ninth determination unit XOR7, XOR8 and XOR9 from the decoder Dec.

Each of the first to third current calculation units Cal1, Cal2 and Cal3 receives C1, C2 and C3 from the first to the third summing unit Intl, Int2 and Int3, respectively and calculates the magnitude of the displacement current.

Each of the fourth to the sixth current calculation unit Cal4, Cal5 and Cal6 receives C4, C5 and C6 from the fourth to she sixth summing unit Int4, Int5 and Int6, respectively and calculates the magnitude of the displacement current.

Each of the seventh to the ninth current calculation unit Cal7, Cal8 and Cal9 receives C7, C8 and C9 from the seventh to the ninth summing unit Int7, Int8 and Int9, respectively and calculates the magnitude of the displacement current.

The first current summing unit Add1 sums the magnitude of the displacement current calculated from each of the first to third current calculation unit Cal1, Cal2 and Cal3.

The second current summing unit Add2 sums the magnitude of the displacement current calculated from each of the fourth to sixth current calculation unit Cal4, Cal5 and Cal6.

The third current summing unit Add3 sums the magnitude of the displacement current calculated from each of the seventh to the ninth current calculation unit Cal7, Cal8 and Cal9.

Thus, the magnitude of the displacement current for the variation of image data corresponding to each cell can be calculated in the above way.

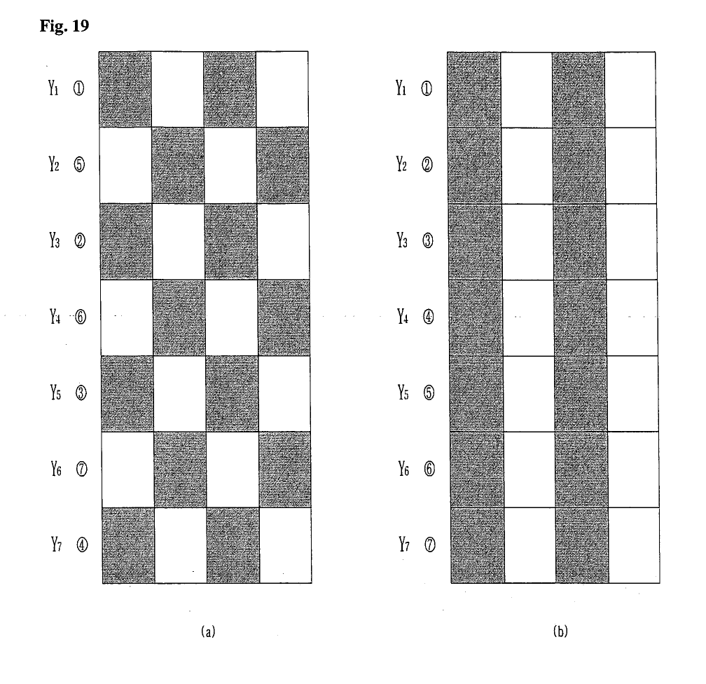

FIG. 16 is a block diagram of data comparison unit 1000 and a scan order determination unit 1001 of a scan driver in a plasma display apparatus of the present invention considering FIGS. 14 and 15.

Referring to FIG. 16, the data comparison unit 1000 considering FIGS. 14 and 15 has a configuration in which the 4 basic blocks shown in FIG. 16, i.e. the first to fourth current determination unit 2010′, 2020′, 2030′ and 2040′ are connected to one another, and the scan order determination unit 1001 compares outputs of 4 basic blocks and determines the scan order which causes the lowest displacement current to be generated.

At this time, the first current determination unit 2010′ compares the image data l, qB with the image data l, qG, the image data l, qG with the image data l, qB, the image data l, qB with the image data l, q−4R, the image data l−4, qR with the image data l−4, qG, the image data l−4, qG with the image data l−4, qB, the image data l−4, qB with the image data l−4, q−1R, the image data l, qR with the image data l−4, qR, the image data l, qG with the image data l−4, qG and the image data l, qB with the image data l−4, qB, respectively.

At this time, l and l−4 refer to the lth scan electrode line and l−4th scan electrode line, respectively. qR, qG and qB refer to the R, G, B cell of the qth pixel, respectively. q−1R, q−1G and q−1B refer to the R, G, B cell of the q−1th pixel, respectively.

Accordingly, the first current determination unit 2010′ compares the image data to thereby calculate the magnitude of the displacement current corresponding to the scan order Type4.

The second current determination unit 2020′ compares the image data l, qR with the image data l, qG, the image data l, qG with the image data l, qB, the image data l, qB with the image data l, q−1R, the image data l−3, qR with the image data l−3, qG, the image data l−3, qG with the image data l−3, qB, the image data l−3, qB with the image data l−3, q−1R, the image data l, qR with the image data l−3, qR, the image data l, qG with the image data l−3, qG and the image data l, qB with the image data l−3, qB, respectively. At this time, l and l−3 refer to the lth scan electrode line and l−3th scan electrode line, respectively.

Accordingly, the second current determination unit 2020′ compares the image data to thereby calculate the magnitude of the displacement current corresponding to the scan order Type3.

The third current determination unit 2030′ compares the image data l, qR with the image data l, qG, the image data l, qG with the image data l, qB, the image data l, qB with the image data l, q−1R, the image data l−2, qR with the image data l−2, qG, the image data l−2, qG with the image data l−2, qB, the image data l−2, qB with the image data l−2, q−1R, the image data l, qR with the image data l−2, qR, the image data l, qG with the image data l−2, qG and the image data l, qB with the image data l−2, qB, respectively. At this time, l and l−2 refer to the lth scan electrode line and l−2th scan electrode line, respectively.

Accordingly, the third current determination unit 2030′ compares the image data to thereby calculate the magnitude of the displacement current corresponding to the scan order Type2.

The fourth current determination unit 2040′ compares the image data l, qR with the image data l, qG, the image data l, qG with the image data l, qB, the image data l, qB with the image data l, q−1R, the image data l−1, qR with the image data l−1, qG, the image data l−1, qG with the image data l−1, qB, the image data l−1, qB with the image data l−1, q−1R, the image data l, qR with the image data l−1, qR, the image data l, qG with the image data l−1, qG and the image data l, qB with the image data l−1, qB, respectively. At this time, l and l−1 refer to the lth scan electrode line and l−1th scan electrode line, respectively.

Accordingly, the fourth current determination unit 2040′ compares the image data to thereby calculate the magnitude of the displacement current corresponding to the scan order Type1.

The scan order determination unit 1001 receives the magnitude of the displacement current calculated by each of the first to fourth current determination unit 2010′, 2030′, 2050′, 2070′ and determines the scan order according to the current determination units having outputted the lowest displacement current thereof.

For example, if the scan order determination unit 1001 determines the displacement current received from the second current determination unit 2030′ is lowest, then it 1001 causes the scan order to be the same as the third scan type Type 3 in FIG. 14, i.e. in the order as Y1-Y4-Y7- . . . , Y2-Y5-Y8- . . . , and Y3-Y6-Y9- . . . .

In addition, if the scan order determination unit 1001 determines the displacement current received from the third current determination unit 2050′ is lowest, then it 1001 causes the scan order to be the same as the second scan type Type 2 in FIG. 7, i.e. in the order as Y1-Y3-Y5- . . . , and Y2-Y4-Y6- . . . .

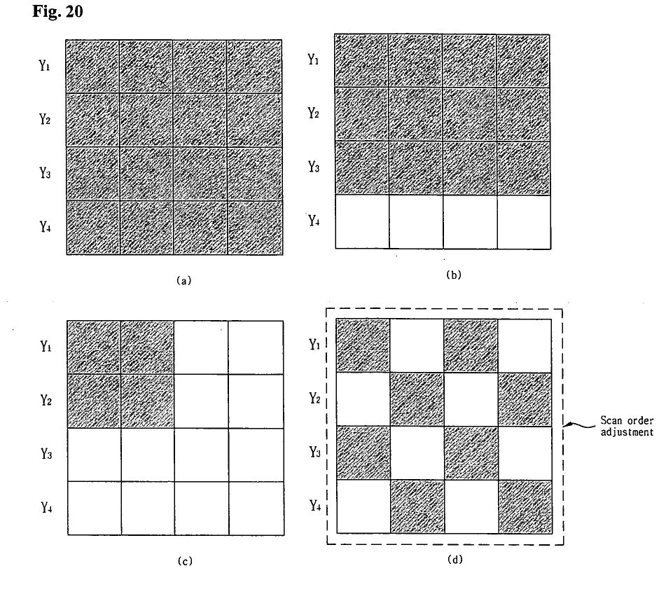

FIG. 17 is a block diagram of an embodiment in which a scan comparison unit and a scan order determination unit are applied on each subfield basis.

Referring to FIG. 17, each of the data determination unit for the first subfield SF1 to the data determination unit for the sixteenth subfield SF16 calculates and temporarily stores the magnitude of the displacement current according to the image pattern in corresponding subfield for a plurality of scan types.

Each of the data determination units for the first to sixteenth subfields SF1 to SF16 has the same block configuration as that of the data comparison unit shown in FIG. 12, and it calculates and temporarily stores the magnitude of the displacement current according to the image data pattern in each subfield for the plurality of scan types.

The scan order determination unit 1001 compares the magnitude of the displacement current according to the image data pattern in each subfield inputted from the temporary storage unit 800 and verify the image data pattern having the lowest displacement current to thereby determine the scan order in each subfield.

As such, the plasma display apparatus and the driving method thereof according to the present invention are characterized by calculating the displacement current between scan electrode lines corresponding to each of a plurality of scan types and sequentially scanning the lines corresponding to the scan type having the lowest displacement current.

In other words, although FIG. 7 illustrates an embodiment in which the displacement current between lines regularly spaced by the predetermined number of scan types is calculated and the scan type having the lowest displacement current is selected, another embodiment is also possible, in which the displacement current between lines spaced irregularly or by any regulations is calculated and the scan type having the lowest displacement current is selected. In addition, although the displacement current is calculated using the weight values Cm2, Cm1+Cm2, or 4Cm1+Cm2 including at least either one of capacitances Cm1, Cm2, it can also be calculated by summing “u0”v or “u1”v, wherein “u0”v is the magnitude of the displacement current in case where the displacement current is not flowing, and “u1”v is the maginitude of displacement current in case where the displacement current is flowing without using the weight values. For example, in FIG. 9, the first to third summing units 736-1 to 736-3 can be configured as one summing unit, and the current calculation units 737-1 to 737-3 and current summing unit 738 can be omitted. In this case, the output frequency of C1, C2 and C3 is counted in one summing unit, and the count value itself is generated as the displacement current.

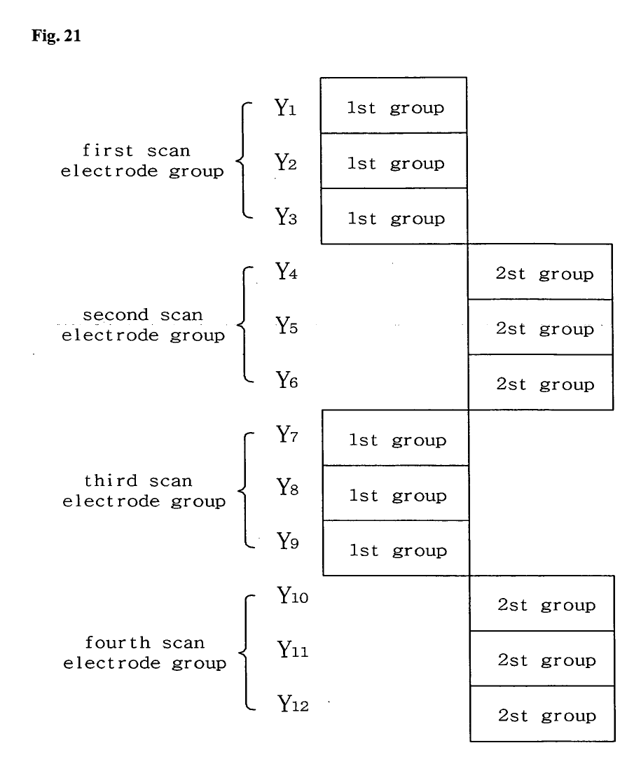

On the other hand, the subfield of scanning the scan electrodes Y with any one of a plurality of scan types as mentioned above can be determined optionally in one frame, which will be described with reference to FIG. 18.

FIG. 18 illustrates an embodiment of a method of selecting a subfield scanning scan electrodes with any one of a plurality of scan types within a frame.

Referring to FIG. 18, the scan electrodes Y are scanned with the first scan type Type1 in FIG. 7 in only the first subfield having the lowest weight value of subfields included in one frame, and the scan electrodes Y are scanned in the normal method, i.e. in the sequential scanning method in the other subfields. More specifically, the displacement current for a plurality of scan types in one and more subfields selected from subfields of one frame is calculated, and the scan electrodes Y are scanned with the scan type having the lowest displacement current in each subfield.

However, it is more preferred that the displacement current is calculated for the plurality of scan types in each subfield included in one frame as shown in FIG. 17, and the scan electrodes Y are scanned with the scan type having the lowest displacement current in each subfield.

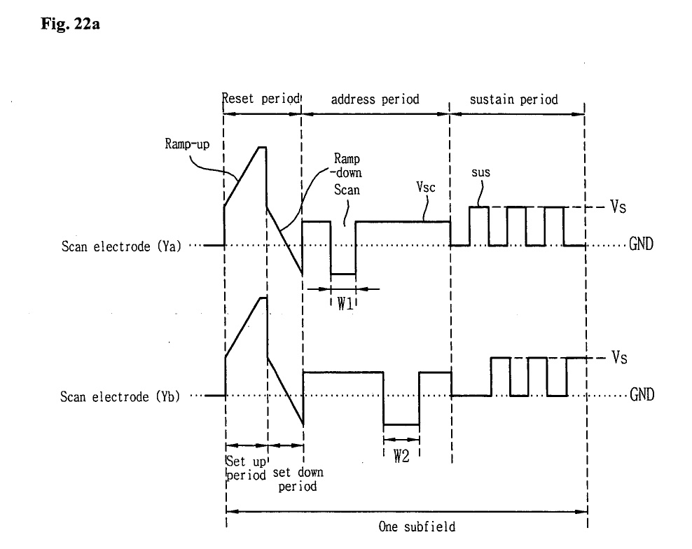

Referring to the above description, it can be seen that in case where the image data pattern comprises a first and a second patterns, the scanning order of the first and second patterns of the image data can be different from each other. This will be described as follows with reference to FIG. 19.

FIG. 19 illustrates a possibility that scan orders may differ from one another in a pattern of two different image data.

Referring to FIG. 19, the image data pattern is shown in (a), in which logic levels ‘1’ and ‘0’ are alternately arranged in the upper, lower, left and right directions, and the image data pattern is shown in (b), in which logic levels ‘1’ and ‘0’ are alternately arranged in the left and right directions, but they are not changed in the upper and lower directions.

Here, the scan order of the scan electrodes Y is in the order of Y1-Y3-Y5-Y7-Y2-Y4-Y6 in the image data pattern as shown in (a), and the scan order of the scan electrodes Y is in the order of Y1-Y2-Y3-Y4-Y5-Y6-Y7 in the image data pattern as shown in (b). In other words, the scan orders of the scan electrodes Y in the image data patterns as shown in (a) and (b) are different from each other.

As such, the reason why the scan order of the scan electrodes Y is adjusted was described above, and thus the detailed description thereof will be omitted.

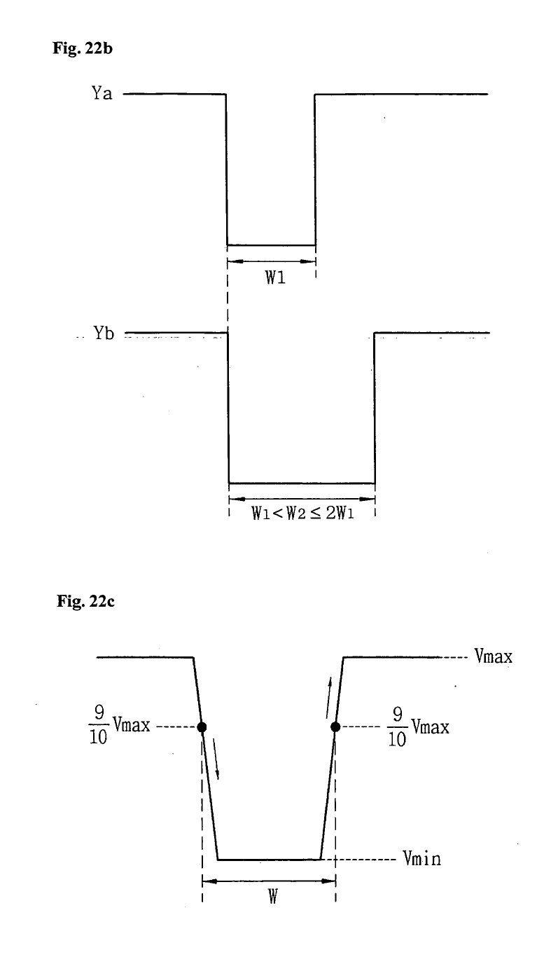

On the other hand, it is preferred that a threshold for the image data pattern is predefined, and the scanning order is adjusted according to the predefined threshold, in case where the scanning order of the scan electrodes Y is adjusted considering the image data pattern as mentioned above, which will be described as follows with reference to FIG. 20.

FIG. 20 illustrates an embodiment of a method of adjusting a scan order by establishing a threshold value according to a pattern of an image data.

Referring to FIG. 20, FIG. 20(a) shows the case that all the image data have a high level, i.e. the logic level is ‘1’, FIG. 20(b) shows the case that all the logic levels on the scan electrode lines Y1, Y2, Y3 are ‘1’, and all the logic levels on the scan electrode line Y4 are ‘0’, FIG. 20(c) shows the case that the all the logic levels on the first and second scan electrodes in the scan electrode lines Y1 and Y2 are ‘1’, and all the logic levels on the third and fourth scan electrodes in the scan electrode lines Y1 and Y2 have a logic level ‘0’, and all the logic levels on the scan electrode lines Y3 and Y4 are ‘1’, and FIG. 4(d) shows the case that the logic levels ‘1’ and ‘0’ are alternately arranged.

Here, a total number of switchings are 0 since the switching of the data driver integrated circuit is not generated in FIG. 20(a), a total 4 switchings of the data driver integrated circuit are generated in the upper and lower directions in FIG. 20(b), a total 2 switchings in the upper and lower directions and a total 2 switchings in the left and right directions are generated in FIG. 20(c), and a total 12 switchings in the upper and lower directions and a total 12 switchings in the left and right directions are generated in FIG. 20(d). Referring to FIG. 20, it can be seen that the case illustrated in FIG. 20(d) has the largest load depending on the pattern.

Here, it is preferred that the load value depending on the data pattern is sought by the sum of load value in the horizontal direction and load value in the vertical direction as mentioned above.

At this time, assuming that the predefined threshold load value is from a total 10 switchings in the upper and lower directions and a total 10 switchings in the left and right directions, only the pattern as shown in FIG. 20(d) among the patterns as shown in FIGS. (a), (b), (c), and (d) is beyond the predefined threshold load value.

As such, it can be understood from the above description of the present invention that to be beyond the threshold load value means that the magnitude of the displacement current according to the data pattern is above the predefined threshold current.

In this case, the pattern as shown in FIG. 20(d) causes the scanning order of the scan electrodes Y to be adjusted when the image data is supplied. The adjustment of scanning order of the scan electrodes Y has been described above in the detailed, and thus repeated description will be omitted.

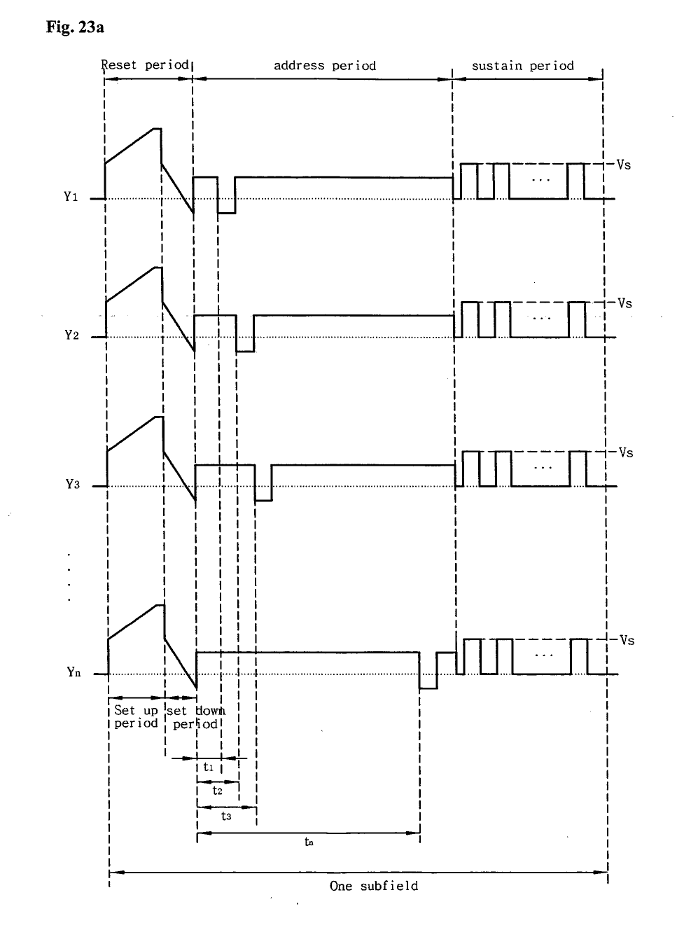

On the other hand, although the description has been made about the case where the scan types each having the scan order corresponding to one scan electrode Y are determined, and the scanning is performed according to the scan order corresponding to one scan electrode Y depending on the scan types, a plurality of scan electrodes Y can be set up as a group of scan electrodes and the scan order corresponding thereto can be determined. This will be described as follows with reference to FIG. 21.

FIG. 21 illustrates an embodiment of a method of determining a scan order corresponding to scan electrode groups, each including a plurality of scan electrodes Y.

Referring to FIG. 21, the scan electrodes Y1, Y2, Y3 are set up as a first group of scan electrodes, the scan electrodes Y4, Y5, Y6 are set up as a second group of scan electrodes, the scan electrodes Y7, Y8, Y9 are set up as a third group of scan electrodes, and the scan electrodes Y10, Y11, Y12 are set up as a fourth group of scan electrodes. Although FIG. 21 illustrates each group of scan electrodes is set up to include 4 scan electrodes, other set-ups are also possible including 2, 3, 5 scan electrodes, etc..

In addition, one and more among a plurality of groups of scan electrodes can be set up to include the scan electrodes Y having a different number of scan electrodes Y from that of the other groups of scan electrodes. For example, it is also possible to be made to include 2 scan electrodes Y in the first group of scan electrodes, and 4 scan electrodes Y in the second group of scan electrodes.

In case of being set up as the groups of scan electrodes, if the second scan type Type 2 in FIG. 7 is applied, the third group of scan electrodes is scanned after the first group of scan electrodes, and then the second and fourth groups of scan electrodes are sequentially scanned. In other words, the scanning order is in the order of Y1, Y2, Y3, Y7, Y8, Y9, Y4, Y5, Y6, Y10, Y11, Y12.

Next, the primary characteristic of a driving method of a plasma display apparatus of the present invention will be described as follows in more detailed, which is related to vary the width of pulse and/or magnitude of voltage of the scan pulse supplied to the scan electrode Y.

As such, a method of varying the width of pulse and/or magnitude of voltage of the scan pulse supplied to the scan electrode Y comprises a method of varying the width of pulse and/or magnitude of voltage of the scan pulse supplied to the scan electrode Y according to the scan order of the scan electrode Y, and a method of varying the width of pulse and/or magnitude of voltage of the scan pulse supplied to the scan electrode Y according to temperature of the plasma display panel.

Here, firstly, a method of varying the width of pulse and/or magnitude of voltage of the scan pulse supplied to the scan electrode Y according to the scan order of the scan electrode Y will be described with reference to FIGS. 22a to 22c.

FIGS. 22a to 22c illustrate an embodiment of a method of varying a width of a scan pulse supplied to a scan electrode Y according to a scan order of the scan electrode Y in a driving method of a plasma display apparatus of the present invention.

Firstly, referring to FIG. 22a, a driving method of a plasma display apparatus of the present invention is to drive the plasma display apparatus with a driving waveform divided into a reset period, an address period, and a sustain period as shown in FIG. 4. An erase period can be further included therein to erase a part of wall charges excessively formed within the discharge cell.

In the set up period of the reset period, the scan electrode Y is applied with a rising ramp waveform Ramp-up. A weak dark discharge is occurred in the discharge of the entire screen by the rising ramp waveform. Due to this set-up discharge, positive wall charges are accumulated on the data electrode X and sustain electrode Z and negative wall charges are accumulated on the scan electrode Y.

In the set down period, a falling ramp waveform Ramp-down, which starts to fall from the positive voltage being lower than the peak voltage of rising ramp waveform and reaches the specific voltage level below the ground GND level voltage after the rising ramp waveform is supplied to the scan electrode Y, causes a weak erase discharge to occur in the discharge cell to thereby erase enough wall charges excessively formed in the discharge cell. Due to this set down discharge, sufficient wall charges to stably generate a data discharge are uniformly remained in the discharge cell.

In the address period, the scan electrode Y is scanned. In other words, a negative scan pulse falling from a scan reference voltage Vsc is applied to the scan electrode Y, and at the same time a positive data pulse is applied to the data electrode X corresponding to the scan pulse. At this time, when the scan pulse is applied to the scan electrode Y, i.e. when the scan electrode Y is scanned, the width of scan pulse supplied to each of Ya and Yb scan electrodes having the different scan order from each other among a plurality of scan electrodes Y is different from each other. The difference in width of scan pulse is described in more detailed in FIG. 22b.

Referring to FIG. 22b, assuming the scan order of Ya scan electrode is relatively faster than that of Yb scan electrode among Ya and Yb scan electrodes, i.e. assuming Yb scan electrode is scanned after Ya scan electrode is scanned, the width W2 of pulse of scan pulse supplied to Yb scan electrode would be wider than that W1 of scan pulse supplied to Ya scan electrode.

Here, it is preferred that the width W2 of pulse of scan pulse supplied to Yb scan electrode exceeds one time and less than 2 times of the width W1 of pulse of scan pulse supplied to Ya scan electrode. In other words, the following relation is obtained: W1<W2≦2W1.

In the address period, the voltage difference between the scan pulse and data pulse and the wall voltage are added, thus the address discharge is occurred in the discharge cell applied with the data pulse. The wall charges are formed in the discharge cell selected by the address discharge to the extent of causing the discharge to be occurred when the sustain voltage Vs is applied

In the sustain period, a sustain pulse Sus is alternately applied to the scan electrode Y and the sustain electrode Z. The wall voltage within the discharge cell and sustain pulse are added to the discharge cell selected by the address discharge, and thus a sustain discharge, that is, a display discharge is generated between the scan electrode Y and the sustain electrode Z whenever the sustain pulse is applied.

Further, the voltage of an erase ramp waveform Ramp-ers having small width of pulse and voltage level is supplied to the sustain electrode Z in the erase period after the sustain discharge is completed, and thus the wall charges residing in the discharge cell of the entire screen can be erased.

The width of pulse of the scan pulse is described in more detained in FIG. 22c.

As shown in FIG. 22c, the width of scan pulse is preferably between the time point where the average voltage of the scan pulse supplied to the scan electrode Y starts to gradually fall from the maximum voltage Vmax in the direction of arrow and then reaches less than 90% (9Vmax/10) of the maximum voltage during the scanning of the scan electrode Y and the time point where the average voltage of the scan pulse supplied to the scan electrode Y starts to gradually rise from the minimum voltage Vmin in the direction of arrow and then reaches more than 90% (9Vmax/10) of the maximum voltage during the scanning of the scan electrode Y.

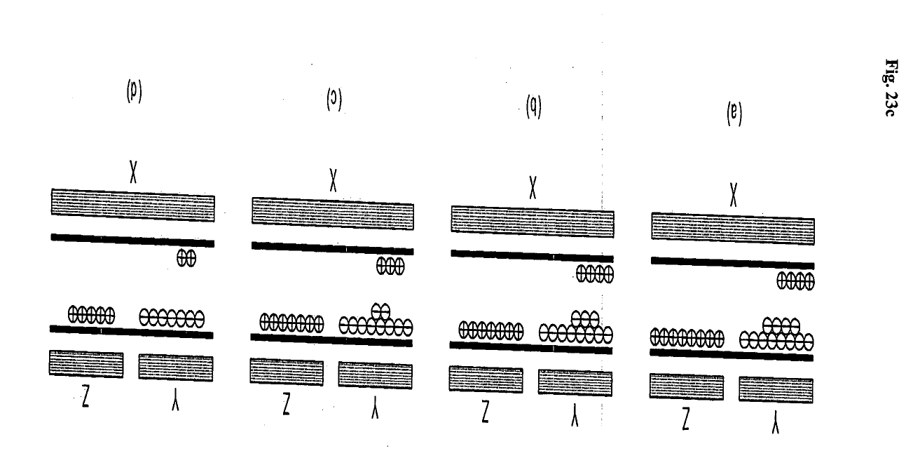

As such, the reason why the width of scan pulse supplied to two scan electrodes having the different scan order, i.e. Ya scan electrode and Yb scan electrode are made to be different from each other will be described with reference to FIGS. 23a to 23c.

FIGS. 23a and 23b illustrate a reason causing widths of each scan pulse supplied to two scan electrodes to be different from each other in a scan order different from each other.

Firstly, referring to FIG. 23a, the order that a plurality of scan electrodes are scanned is shown in the address period. The scanning is sequentially performed according to the scan order of the scan electrode Y in the address period of FIG. 23a. In other words, the time from the time point when the address period starts after the reset period to the time point when the scanning is performed is made to be different in each scan electrode.

For example, as shown in FIG. 23a, each scan electrode is sequentially applied with the scan pulse according to the arrangement order of the scan electrodes Y1˜Yn. For example, the scan pulse is earliest applied to Y1 scan electrode which is the earliest in arrangement order of the plasma display panel, and then Y2 scan electrode having the next order is applied with the scan pulse subsequently to the scan pulse applied to Y1 scan electrode.

In other words, Y1 scan electrode is applied with the scan pulse in the time which a time t1 has lapsed since the time point when the set down of the reset period is ended, and thus an address discharge is occurred, i.e. the scanning is performed, Y2 scan electrode is applied with the scan pulse in the time which a time t2 has lapsed since the time point when the set down of the reset period is ended, and thus an address discharge is occurred, and Y3 scan electrode is applied with the scan pulse in the time which a time t3 has lapsed from the time point when the set down of the reset period is ended, and thus an address discharge is occurred. As such, the scan pulse applied to each of all the scan electrodes Y1˜Yn is different in the time point applied from time point when the set down of the reset period is ended.

On the other hand, FIG. 23b illustrates the case that the width of scan pulse supplied to the scan electrodes is all the same unlike the present invention.

In other words, the width of scan pulse supplied to Y1, Y2, Y3, and Y4 scan electrodes is the same as W, respectively.

As such, if the scan pulse having the same width of pulse is supplied to each scan electrode as shown in FIG. 23b in case where the scan electrode is sequentially scanned, the distribution of wall charges generated in the discharge cell according to the scan order of each scan electrode can be changed, which will be described with reference to FIG. 23c.

Referring to FIG. 23c, it can be seen that as the time from the time point when the set down of the reset period is ended to the time point when the scan pulse is supplied to the scan electrodes Y1˜Yn is increased, the rate that the wall charges are decreased in the discharge cell is further increased.

More specifically, in case of t1 where the time difference from the time point when the set down of the reset period is ended as Y1 scan electrode in FIG. 23a to the time point when the scan pulse is supplied is relatively short, for example, the wall charges within the discharge cell are advantageous in the sustain discharge as in (a) of FIG. 23c. An embodiment in which 12 negative charges, 8 positive charges, and 4 negative charges are distributed on the scan electrode Y, sustain electrode Z, and address electrode X, respectively will be described with reference to (a) of FIG. 23c.

Next, in case of t2 when the time difference from the time point when set down of the reset period is ended to the time point when the scan pulse is applied is relatively longer than the t1 as Y2 scan electrode of FIG. 23a, the wall charges are partially reduced in the discharge cell compared to (a), for example, as (b) of FIG. 23c.

Next, in case of t3 when the time difference from the time point when set down of the reset period is ended to the time point when the scan pulse is applied is relatively longer than the t2 as Y3 scan electrode of FIG. 23a, the wall charges are partially reduced in the discharge cell compared to (a) and (b), for example, as (c) of FIG. 23c.

Next, in case of t4 when the time difference from the time point when set down of the reset period is ended to the time point when the scan pulse is applied is relatively longer than the t3 as Yn scan electrode of FIG. 23a, the wall charges are partially reduced in the discharge cell compared to (a), (b) and (c), for example, as (d) of FIG. 23c.

The reason why the amount of wall charges is reduced in the discharge cell, as the time difference from the end of the set down in the reset period to the time point when the scan pulse is applied is increased is because the wall charges formed in the set down period are combined with space charges in the discharge cell to be neutralized as time lapses.

As such, if the time difference from the end of the set down to the time point when the scan pulse is applied in each scan electrode Y1˜Yn is different form one another, then the strength of address discharge is caused to be different in each scan electrode Y1˜Yn. For example, assuming that the distribution of wall charges is represented as in (a) in the time point when the scan pulse is applied to Y1 scan electrode, and thus an address discharge is occurred, and the distribution of wall charges is represented as in (d) in the time point when the scan pulse is applied to Yn scan electrode, and thus an address discharge is occurred, for example, as shown in FIG. 23c, the relatively strong address discharge is occurred in (a), however the relatively weak address discharge is occurred in (d) compared to (a).

As such, if the strength of address discharge is caused to be different from one another according to each scan electrode Y1˜Yn, the strength of sustain discharge is also caused to be different from one another in the subsequent sustain period, and thus it is possible of the brightness difference to be occurred in each scan electrode Y1˜Yn.

In addition, in the above mentioned (d), in case where the time difference from the end of the set down to the time point when the scan pulse is applied is excessively increased, so that the wall charges in the discharge cell are excessively lost, it is possible for the subsequent sustain discharge not to be occurred.

Thus, a method of solving the problems issued in FIGS. 23a to 23c is to cause the width of scan pulse each supplied to two scan electrodes having the different scan order to be different from each other.

In other words, the address discharge is occurred more stably and strongly on the Yb scan electrode rather than Ya scan electrode, by causing the width of scan pulse supplied to Yb scan electrode having the relatively late scan order among Ya and Yb scan electrodes to be wider than the width of scan pulse supplied to Ya scan electrode. Thus, although the wall charges are excessively lost in the discharge cell since the time from the set down of the reset period to the time point when the scan pulse is applied in the address period is lengthened, the wall charges are sustained in the discharge cell corresponding to Yb scan electrode to the extent of making it possible to generate sufficient strength of address discharge.

Thus, it is possible to prohibit the brightness difference between the scan electrodes from being occurred, and as well it is possible to stabilize the address discharge to thereby stabilize the entire drive.

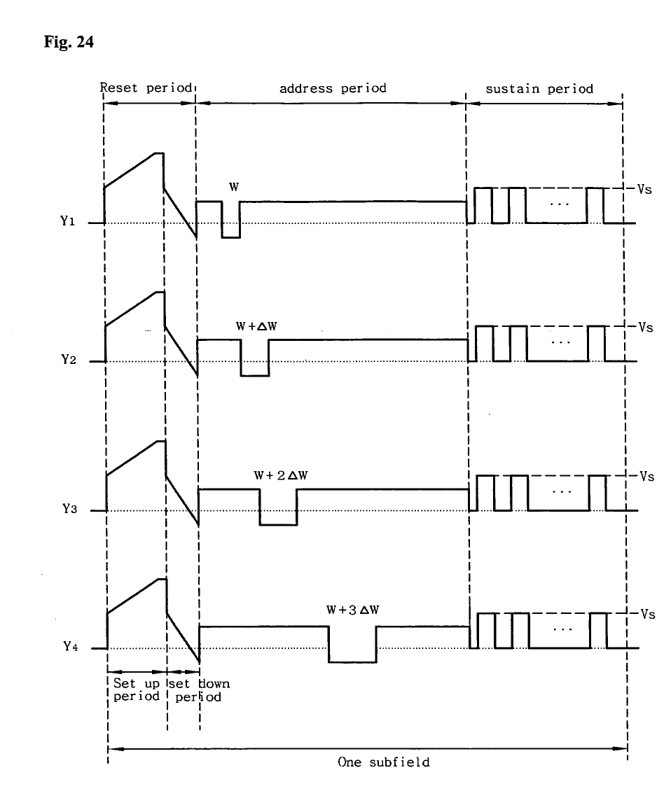

As such, it is possible to cause the difference of the width of pulse between scan pulses to be constant, in case where the width of scan pulse is adjusted according to the scan order, which will be described with reference to FIG. 24.

FIG. 24 illustrates an embodiment of a method of causing the difference in width of scan pulse between scan pulses to be constant.

Referring to FIG. 24, assuming that a plurality of scan electrodes include 4 scan electrodes, i.e. Y1, Y2, Y3, and Y4 scan electrodes having a different scan order, and the scan order of the scan electrodes is in the order of Y1-Y2-Y3-Y4, and assuming that the width of scan pulse supplied to Y1 scan electrode having the earliest scan order in the address period is W, the width of scan pulse supplied to Y2 scan electrode having a later scan order than that of Y1 scan electrode is W+ [symbol] W, which is incremented by [symbol] W.

In addition, the width of scan pulse supplied to Y3 scan electrode having a later scan order than that of Y2 scan electrode is W+2 [symbol] W, which is incremented by [symbol] W from W+ [symbol] W, which is the width of scan pulse supplied to the Y2 scan electrode, and the width of scan pulse supplied to Y4 scan electrode having a later scan order than that of Y3 scan electrode is W+3 [symbol] W, which is incremented by [symbol] W from W+2 [symbol] W, which is the width of scan pulse supplied to the Y3 scan electrode.

In other words, as the scan order is incremented by one, the width of scan pulse is also incremented by [symbol] W.

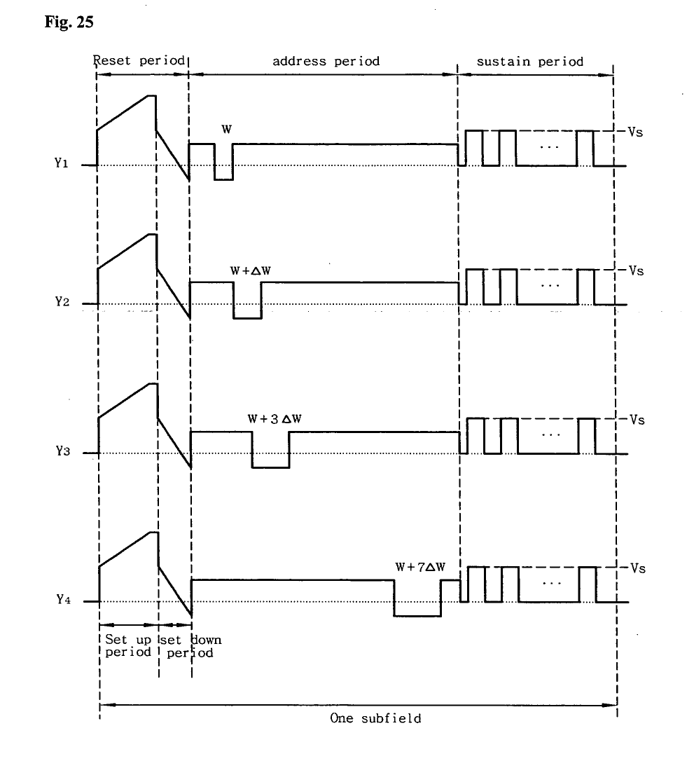

Unlike the method shown in FIG. 24, it is possible to cause the difference of the width of pulse between scan pulses to be different from one another, in case where the width of scan pulse is adjusted according to the scan order, which will be described with reference to FIG. 25.

FIG. 25 illustrates an embodiment of a method of causing the difference in width of scan pulse between scan pulses to be different.

Referring to FIG. 25, assuming that a plurality of scan electrodes include 4 scan electrodes, i.e. Y1, Y2, Y3, and Y4 scan electrodes having a different scan order, and the scan order of the scan electrodes is in the order of Y1-Y2-Y3-Y4, and assuming that the width of scan pulse supplied to Y1 scan electrode having the earliest scan order in the address period is W, the width of scan pulse supplied to Y2 scan electrode having a later scan order than that of Y1 scan electrode is W+ [symbol] W, which is incremented by [symbol] W.

In addition, the width of scan pulse supplied to Y3 scan electrode having a later scan order than that of Y2 scan electrode is W+3 [symbol] W, which is incremented by 2 [symbol] W from W+ [symbol] W, which is the width of scan pulse supplied to the Y2 scan electrode, and the width of scan pulse supplied to Y4 scan electrode having a later scan order than that of Y3 scan electrode is W+7 [symbol] W, which is incremented by 4 [symbol] W from W+3 [symbol] W, which is the width of scan pulse supplied to the Y3 scan electrode.

In other words, as the scan order is incremented by one, the width of scan pulse is also incremented by [symbol] W, 2 [symbol] W, or 4 [symbol] W.

Although FIG. 25 illustrates the case that the difference of width of scan pulse is different from each other, it is also possible to cause only the difference of width of scan pulse supplied to the predetermined scan electrode to be different. For example, as shown in FIG. 25, Y1, Y2, and Y3 scan electrodes are supplied with the scan pulse having a width of pulse W, and Y4 scan electrode are supplied with the scan pulse having a width of pulse W+3 [symbol] W.

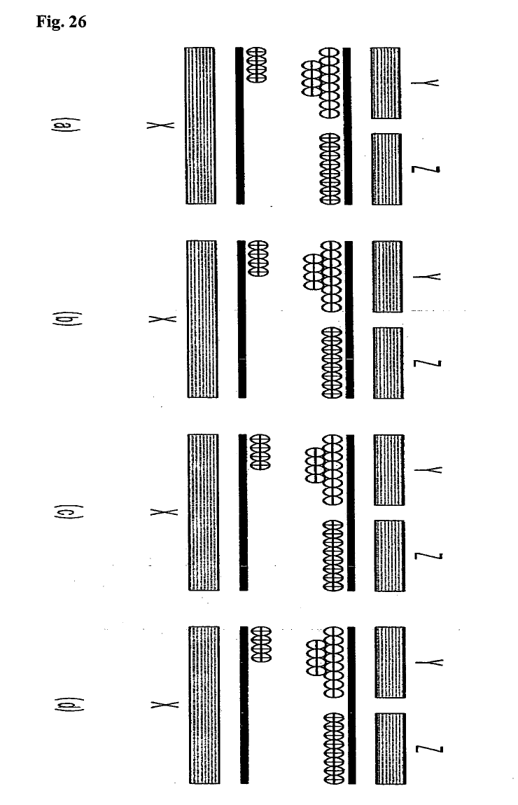

The distribution of the wall charges in the discharge cell according to the driving method as shown in FIGS. 24 or 25 will be described with reference to FIG. 26.

FIG. 26 illustrates a variation of distribution of wall charges in an address period in a driving method of the present invention.

It should be noted that FIG. 26 is a view for conceptually illustrating a variation of distribution of wall charges in an address period in a driving method of the present invention, thus the distribution of the wall charges in the address period is not necessarily to follow the distribution shown in FIG. 26.

Referring to FIG. 26, if the scan pulse having a width of pulse W is supplied to, for example, Y1 scan electrode as shown in FIGS. 24 or 25 having the earliest scan order, the wall charges are advantageous in the sustain discharge in the discharge cell corresponding to Y1 scan electrode, for example, in the discharge cell as (a) of FIG. 26. For example, 12 negative charges, 8 positive charges, and 4 negative charges are distributed on the scan electrode Y, sustain electrode Z, and address electrode X, respectively.

Next, if the scan pulse having a wider width of pulse than that of Y1 electrode, for example, the width of pulse W+ [symbol] W is supplied in case having a later scan order than that of Y1 scan electrode as Y2 scan electrode of FIGS. 24 or 25, the wall charges are distributed in the discharge cell corresponding to Y2 scan electrode, for example, in the discharge cell as (b) of FIG. 26 to be advantageous in the sustain discharge similarly to (a).

Next, if the scan pulse having a wider width of pulse than that of Y1, Y2 electrodes, for example, the width of pulses W+2 [symbol] W or W+3 [symbol] W is supplied in case having a later scan order than that of Y1, Y2 scan electrodes as Y3 scan electrode of FIGS. 24 or 25, the wall charges are distributed in the discharge cell corresponding to Y3 scan electrode, for example, in the discharge cell as (c) of FIG. 26 to be advantageous in the sustain discharge similarly to (a) and (b).

Next, if the scan pulse having a wider width of pulse than that of Y1, Y2, Y3 electrodes, for example, the width of pulses W+3 [symbol] W or W+7 [symbol] W is supplied in case having a later scan order than that of Y1, Y2, Y3 scan electrodes as Y4 scan electrode of FIGS. 24 or 25, the wall charges are distributed in the discharge cell corresponding to Y4 scan electrode, for example, in the discharge cell as (d) of FIG. 26 to be advantageous in the sustain discharge similarly to (a), (b) and (c).

Thus, the wall charges are uniformly and similarly distributed in the discharge cell in the time point when the address discharge is occurred in all cases of (a), (b), (c), and (d) of FIG. 26. In the result, the distribution of wall charges in all the discharge cells after the address discharge is caused to be advantageous in the subsequent sustain discharge.

Thus, the brightness difference of the screen is prohibited to be generated, and thus the image quality can be enhanced.

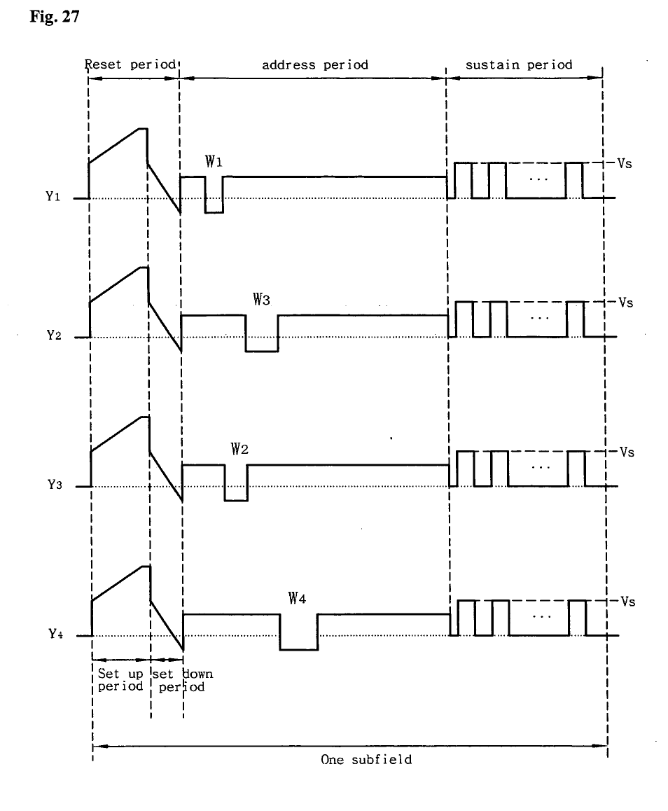

FIGS. 24 or 25 illustrate an embodiment applied to only the first scan type Type1 when the width of scan pulse is adjusted considering to FIG. 7. However, the method of adjusting the width of scan pulse can be applied to various scan types. For example, another embodiment in which a method of causing the width of pulse between the scan pulses to be different in the second scan type Type2 is applied will be described with reference to FIG. 27.

FIG. 27 illustrates an embodiment of a method causing a width of pulse between scan pulses to be different in a second scan type (Type2).

Referring to FIG. 27, assuming that a plurality of scan electrodes include 4 scan electrodes, i.e. Y1, Y2, Y3, and Y4, and the scan order of the 4 scan electrodes is in the order of Y1-Y2-Y3-Y4, and assuming that the width of scan pulse supplied to Y1 scan electrode in the address period is W, the width of scan pulse supplied to Y3 scan electrode having a later scan order than that of Y1 scan electrode is W2, which is wider than the W.

In addition, the width of scan pulse supplied to Y2 scan electrode, adjacent to Y3 scan electrode and having a later scan order than that of Y3 scan electrode is W3, which is wider than the W2 which is the width of scan pulse supplied to Y3 scan electrode, and the width of scan pulse supplied to Y4 scan electrode having a later scan order than that of Y2 scan electrode is W4, which is wider than the W3 which is the width of scan pulse supplied to Y2 scan electrode.

In other words, in case where the scan order of the scan electrode Y is changed, the width of scan pulse is adjusted according to the changed scan order.

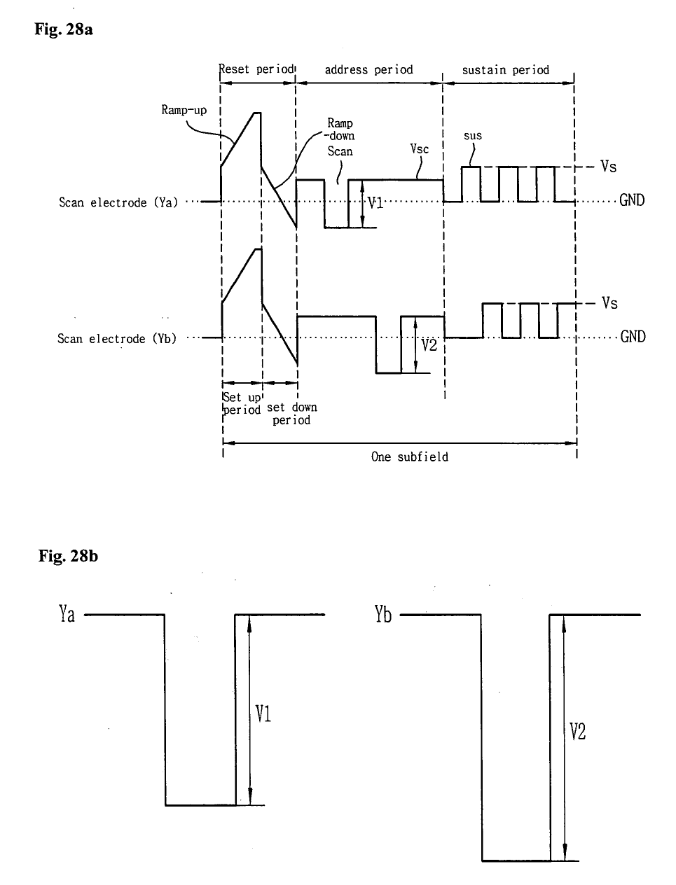

Next, an embodiment of varying a magnitude of voltage of a scan pulse supplied to a scan electrode Y according to a scan order of the scan electrode Y in a driving method of a plasma display apparatus of the present invention will be described as follows with reference to FIGS. 28a and 28b.

FIGS. 28a and 28b illustrate an embodiment of a method of varying a maginitude of voltage of a scan pulse supplied to a scan electrode Y according to a scan order of the scan electrode Y in a driving method of a plasma display apparatus of the present invention.

Firstly, referring to FIG. 28a, when the scan pulse is supplied to the scan electrode Y in the address period, i.e. when the scan electrode Y is scanned, the magnitude of the voltage of the scan pulse supplied to each of Ya and Yb scan electrodes having the different scan order from each other among a plurality of scan electrodes Y is different from each other. The difference in magnitude of voltage of scan pulse is described in more detailed in FIG. 28b.

Referring to FIG. 28b, assuming the scan order of Ya scan electrode is relatively faster than that of Yb scan electrode among Ya and Yb scan electrodes, i.e. assuming Yb scan electrode is scanned after Ya scan electrode is scanned, the magnitude of voltage V2 of pulse of scan pulse supplied to Yb scan electrode would be wider than that V1 of scan pulse supplied to Ya scan electrode.

Here, it is preferred that the magnitude of voltage V2 of pulse of scan pulse supplied to Yb scan electrode exceeds one time and less than 1.5 times of the magnitude of voltage V1 of pulse of scan pulse supplied to Ya scan electrode. In other words, the following relation is obtained: V1<V2≦(1.5)V1.

As such, the reason why the magnitude of the voltage of the scan pulse supplied to two scan electrodes having the different scan order, i.e. Ya scan electrode and Yb scan electrode are made to be different from each other will be described as follows.

In other words, the address discharge is occurred more stably and strongly on the Yb scan electrode rather than Ya scan electrode, by causing the magnitude of the voltage of the scan pulse supplied to Yb scan electrode having the relatively late scan order among Ya and Yb scan electrodes to be greater than the magnitude of the voltage of the scan pulse supplied to Ya scan electrode. Thus, although the wall charges are excessively lost in the discharge cell since the time from the set down of the reset period to the time point when the scan pulse is applied in the address period is lengthened, the wall charges are sustained in the discharge cell corresponding to Yb scan electrode to the extent of making it possible to generate sufficient strength of address discharge.

Thus, it is possible to prohibit the brightness difference between the scan electrodes from being occurred, and as well it is possible to stabilize the address discharge to thereby stabilize the entire drive.

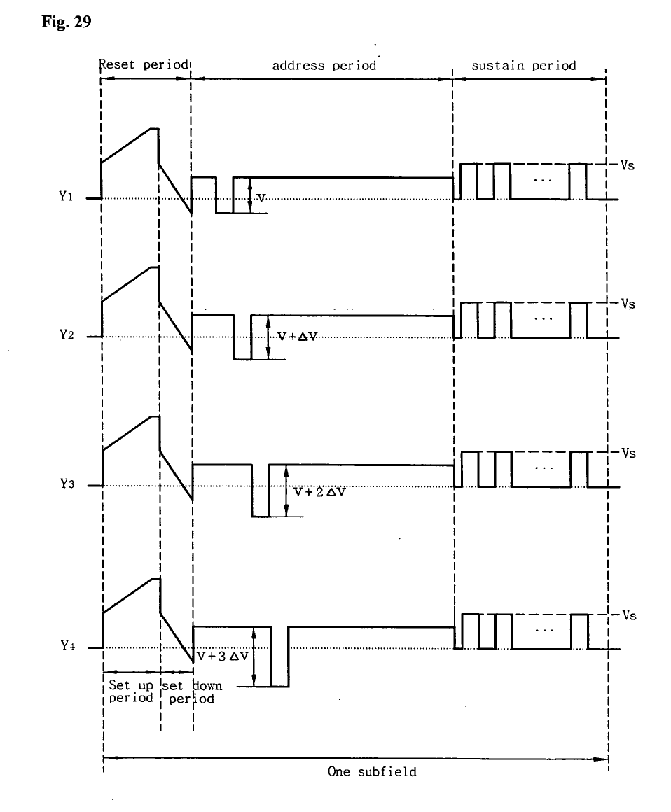

As such, it is possible to cause the difference of the voltage of pulse between scan pulses to be constant, in case where the magnitude of the voltage of the scan pulse is adjusted according to the scan order, which will be described with reference to FIG. 29.

FIG. 29 illustrates an embodiment of a method of causing the difference in voltage of scan pulse between scan pulses to be constant.

Referring to FIG. 29, assuming that a plurality of scan electrodes include 4 scan electrodes, i.e. Y1, Y2, Y3, and Y4 scan electrodes having a different scan order, and the scan order of the scan electrodes is in the order of Y1-Y2-Y3-Y4, and assuming that the magnitude of the voltage of the scan pulse supplied to Y1 scan electrode having the earliest scan order in the address period is V, the magnitude of the voltage of the scan pulse supplied to Y2 scan electrode having a later scan order than that of Y1 scan electrode is V+ [symbol] V, which is incremented by [symbol] V.

In addition, the magnitude of the voltage of the scan pulse supplied to Y3 scan electrode having a later scan order than that of Y2 scan electrode is V+2 [symbol] V, which is incremented by [symbol] V from V+ [symbol] V, which is the magnitude of the voltage of the scan pulse supplied to the Y2 scan electrode, and the magnitude of the voltage of the scan pulse supplied to Y4 scan electrode having a later scan order than that of Y3 scan electrode is V+3 [symbol] V, which is incremented by [symbol] V from V+2 [symbol] V, which is the magnitude of the voltage of the scan pulse supplied to the Y3 scan electrode.

In other words, as the scan order is incremented by one, the magnitude of the voltage of the scan pulse is also incremented by [symbol] V.

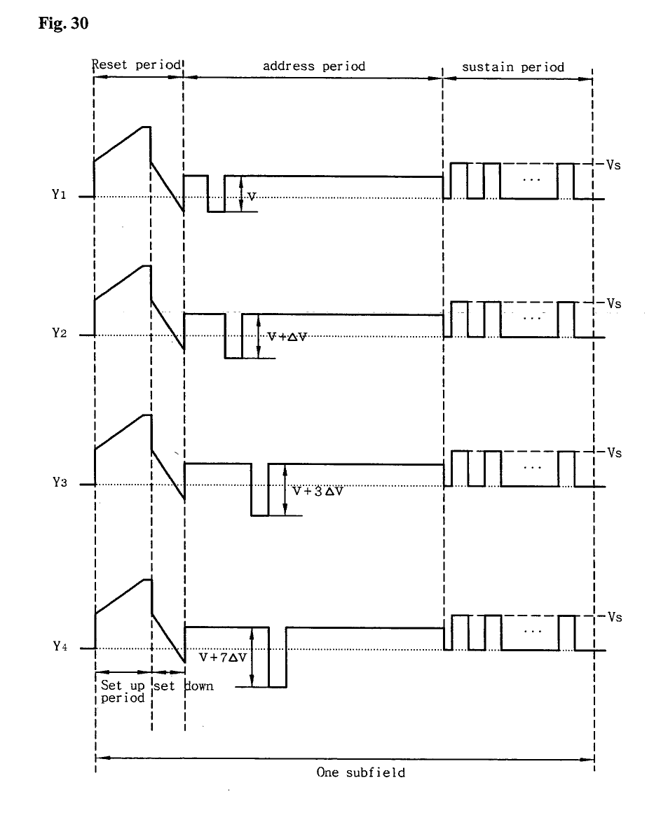

Unlike the method shown in FIG. 29, it is possible to cause the difference of the magnitude of voltage of pulse between scan pulses to be different from one another, in case where the magnitude of the voltage of the scan pulse is adjusted according to the scan order, which will be described as follows with reference to FIG. 30.

FIG. 30 illustrates an embodiment of a method of causing the difference in voltage of scan pulse between scan pulses to be different.

Referring to FIG. 30, assuming that a plurality of scan electrodes include 4 scan electrodes, i.e. Y1, Y2, Y3, and Y4 scan electrodes having a different scan order, and the scan order of the scan electrodes is in the order of Y1-Y2-Y3-Y4, and assuming that the magnitude of the voltage of the scan pulse supplied to Y1 scan electrode having the earliest scan order in the address period is V, the magnitude of the voltage of the scan pulse supplied to Y2 scan electrode having a later scan order than that of Y1 scan electrode is V+ [symbol] V, which is incremented by [symbol] V.

In addition, the magnitude of the voltage of the scan pulse supplied to Y3 scan electrode having a later scan order than that of Y2 scan electrode is V+3 [symbol] V, which is incremented by 2 [symbol] V from V+ [symbol] V, which is the magnitude of the voltage of the scan pulse supplied to the Y2 scan electrode, and the magnitude of the voltage of the scan pulse supplied to Y4 scan electrode having a later scan order than that of Y3 scan electrode is V+7 [symbol] V, which is incremented by 4 [symbol] V from V+3 [symbol] V, which is the magnitude of the voltage of the scan pulse supplied to the Y3 scan electrode.

In other words, as the scan order is incremented by one, the magnitude of the voltage of the scan pulse is also incremented by [symbol] V, 2 [symbol] V or 4 [symbol] V.

Although FIG. 30 illustrates the case that the difference of the magnitude of the voltage of the scan pulse is different from each other, it is also possible to cause only the difference of the magnitude of the voltage of the scan pulse supplied to the predetermined scan electrode to be different. For example, as shown in FIG. 30, Y1, Y2, and Y3 scan electrodes are supplied with the scan pulse having a magnitude of voltage of pulse V, and Y4 scan electrode are supplied with the scan pulse having a magnitude of voltage of pulse V+3 [symbol] V.

The distribution of wall charges in the discharge cell according to the driving method as shown in FIGS. 29 or 30 follows the same pattern as that described with reference to FIG. 26.

In other words, the wall charges are uniformly and similarly distributed in the discharge cell in the time point when the address discharge is occurred in all cases of Y1, Y2, Y3, and Y4 scan electrodes in the driving method as shown in FIGS. 29 or 30. In the result, the distribution of wall charges in all the discharge cells after the address discharge is caused to be advantageous in the subsequent sustain discharge.

Thus, the brightness difference of the screen is prohibited to be generated, and thus the image quality can be enhanced.

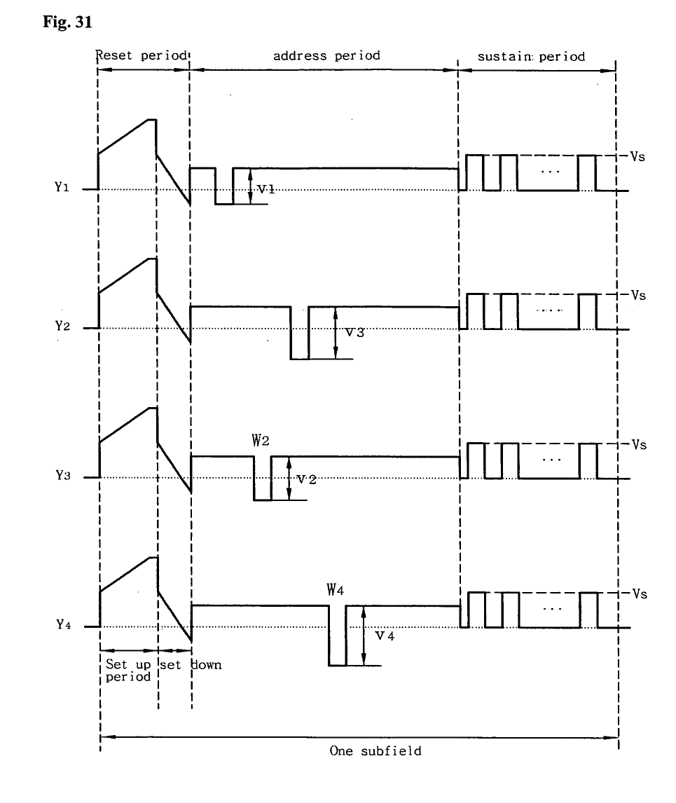

FIGS. 29 or 30 illustrate an embodiment applied to only the first scan type Type1 when the magnitude of the voltage of the scan pulse is adjusted considering to FIG. 7. However, the method of adjusting the magnitude of the voltage of the scan pulse can be applied to various scan types. For example, another embodiment in which a method of causing the magnitude of voltage of pulse between the scan pulses to be different in the second scan type Type2 is applied will be described with reference to FIG. 31.

FIG. 31 illustrates an embodiment of a method causing a magnitude of voltage of pulse between scan pulses to be different in a second scan type Type2.

Referring to FIG. 31, assuming that a plurality of scan electrodes include 4 scan electrodes, i.e. Y1, Y2, Y3, and Y4, and the scan order of the 4 scan electrodes is in the order of Y1-Y2-Y3-Y4, and assuming that the magnitude of the voltage of the scan pulse supplied to Y1 scan electrode in the address period is V1, the magnitude of the voltage of the scan pulse supplied to Y3 scan electrode having a later scan order than that of Y1 scan electrode is V2, which is wider than the V1.

In addition, the magnitude of the voltage of the scan pulse supplied to Y2 scan electrode, adjacent to Y3 scan electrode and having a later scan order than that of Y3 scan electrode is V3, which is wider than the V2 which is the width of scan pulse supplied to Y3 scan electrode, and the magnitude of the voltage of the scan pulse supplied to Y4 scan electrode having a later scan order than that of Y2 scan electrode is V4, which is wider than the V3 which is the magnitude of the voltage of the scan pulse supplied to Y2 scan electrode.

In other words, in case where the scan order of the scan electrode Y is changed, the magnitude of the voltage of the scan pulse is adjusted according to the changed scan order.

Next, the primary characteristic of a driving method of a plasma display apparatus of the present invention, a method of varying the width of pulse and/or magnitude of voltage of the scan pulse supplied to the scan electrode Y according to the temperature of the plasma display panel, will be described as follows.

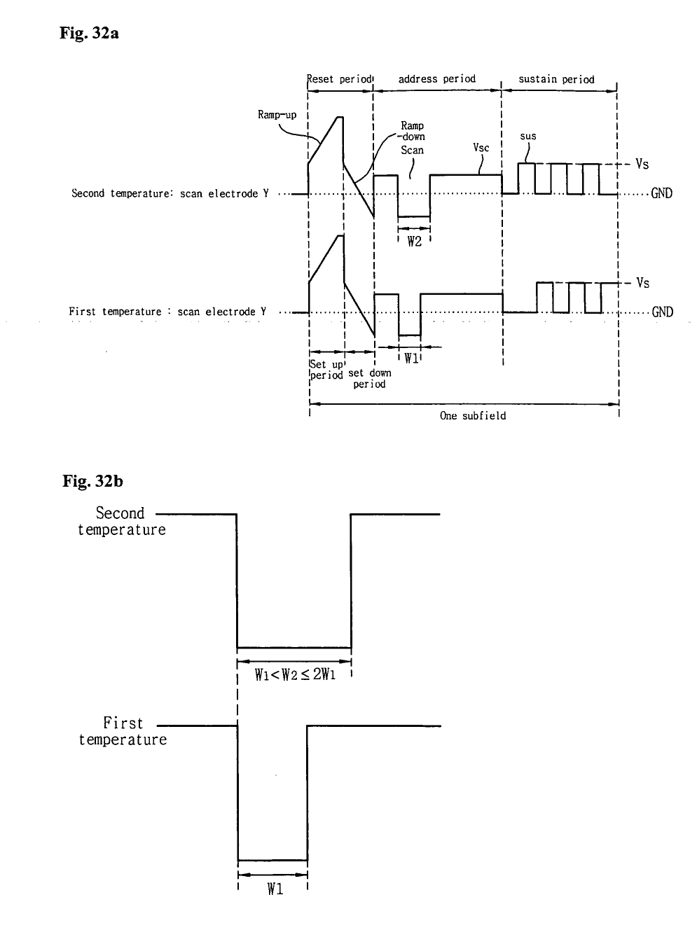

As such, an embodiment of varying a width of pulse of a scan pulse supplied to a scan electrode Y according to temperature of the plasma display panel in a method of varying the width of pulse and/or the magnitude of voltage of the scan pulse supplied to the scan electrode according to temperature of the plasma display panel will be described as follows with reference to FIGS. 32a and 32b.

FIGS. 32a and 32b are view for illustrating an embodiment of a method of varying a width of a scan pulse supplied to a scan electrode Y according to temperature of a plasma display panel in a driving method of a plasma display apparatus of the present invention.

Firstly, referring to FIG. 32a, in the driving method of the plasma display apparatus of the present invention, when the scan pulse is supplied to the scan electrode Y in the address period, i.e. when the scan electrode Y is scanned, in case where the temperature of the plasma display panel is the first temperature, the width of scan pulse supplied to the scan electrode Y upon scanning the scan electrode Y is made to be different from, in case where the temperature of the plasma display panel is the second temperature different from the first temperature, the width of scan pulse supplied to the scan electrode Y. The difference in width of scan pulse is described in more detailed in FIG. 32b.

Referring to FIG. 32b, assuming that the second temperature is higher than the first temperature among the first and second temperature of the plasma display panel, the width W2 of pulse of the scan pulse supplied to the scan electrode Y in the second temperature is wider than the width W1 of pulse of the scan pulse supplied to the scan electrode Y in the first temperature.

Here, it is preferred that the width W2 of pulse of scan pulse supplied to Yb scan electrode in the second temperature exceeds one time and less than 2 times of the width W1 of pulse of scan pulse supplied to Ya scan electrode in the first temperature. In other words, the following relation is obtained: W1<W2≦2W1.

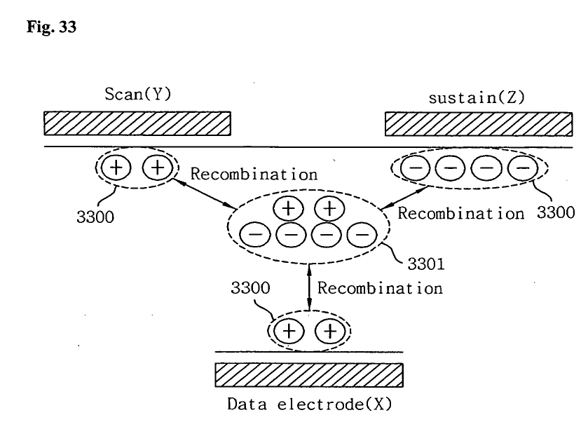

As such, the reason why the width of scan pulse supplied to scan electrode in the first and second temperature, respectively, is made to be different from each other will be described with reference to FIG. 33.

FIG. 33 illustrates a reason adjusting a width of a scan pulse according to temperature of a plasma display panel.

A plasma display apparatus generally generates an undesired discharge due to the temperature of the plasma display panel.

More specifically, in case where the temperature of surroundings of the plasma display panel is relatively high, the recombination rate of space charges 3301 and wall charges 3300 is increased, the absolute amount of wall charge participating in the discharge is reduced, and thus an undesired discharge is generated. Here, the space charges 3301 is the charges residing on space in the discharge cell, and they don't participate in the discharge unlike the wall charges 3300.

For example, in case where the temperature of the plasma display panel is relatively high, the recombination rate of space charges 3301 and wall charges 3300 is increased in the address period, the amount of wall charge 3300 participating in the address discharge is reduced, and thus the address discharge is unstabilized. In this case, since the time when the space charges 3301 and wall charges 3300 can be recombined is sufficiently secured as the scanning order is later, the address discharge is further unstabilized. Thus, the undesired high temperature discharge is occurred for example as ON discharge cell in the address period is changed to OFF discharge cell in the sustain period.

In addition, in case where the temperature of plasma display panel is relatively high, if the sustain discharge is occurred in the sustain period, the speed of space charges 3301 becomes faster during the discharge, and thus the recombination rate of the space charges 3301 and wall charges 3300 is increased. Thus, the amount of wall charge 3300 participating in the sustain discharge is reduced by the recombination of the space charges 3301 and wall charges 3300 after any one sustain discharge, and thus there is a problem that the undesired high temperature discharge is occurred for example as the subsequent sustain discharge is not occurred.

To solve the problem as illustrated in FIG. 33 is to increase the amount of wall charge 3300 formed in the discharge cell in the address period by causing the width of scan pulse supplied to the scan electrode Y to be wider in case where the temperature of the plasma display panel is relatively high, and thus to cause sufficient amount of wall charges to be sustained in the discharge cell, although the recombination rate of the space charges 3301 and wall charges 3300 is increased. Thus, the undesired high temperature discharge is enhanced.

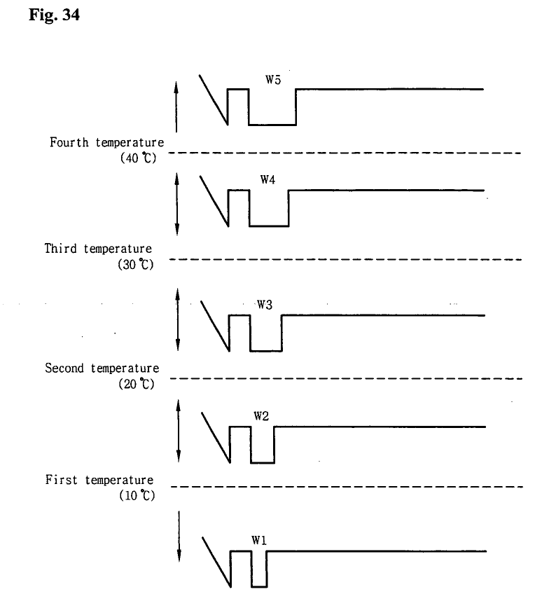

As such, it is possible to predefine a threshold temperature in case where the width of scan pulse is adjusted according to the temperature of plasma display panel and then to adjust the width of scan pulse in case where the temperature of plasma display panel exceeds the threshold temperature, which will be described as follows with reference to FIG. 34.

FIG. 34 illustrates an embodiment of a method of adjusting a width of a scan pulse by establishing threshold temperature.

Referring to FIG. 34, the width of scan pulse is adjusted by predefining the threshold temperature. For example, the threshold temperature is predefined as a first, a second, a third, and a fourth temperature, and the width of scan pulse supplied to the scan electrode Y is referred to as W1 in case where the temperature of plasma display panel is lower than the first temperature.

In addition, the width of scan pulse supplied to the scan electrode Y is referred to as W2 being wider than W1 in case where the temperature of the plasma display panel is higher than the first temperature and lower than the second temperature.

In addition, the width of scan pulse supplied to the scan electrode Y is referred to as W3 being wider than W2 in case where the temperature of the plasma display panel is higher than the second temperature and lower than the third temperature, the width of scan pulse supplied to the scan electrode Y is referred to as W4 being wider than W3 in case where the temperature of the plasma display panel is higher than the third temperature and lower than the fourth temperature, and the width of scan pulse supplied to the scan electrode Y is referred to as W5 being wider than W4 in case where the temperature of the plasma display panel is higher than the fourth temperature.

Here, the first, second, third, and fourth temperature can be changed according to the characteristic of the plasma display panel. For example, the first, second, third, and fourth temperature can be set up as 10° C., 20° C., 30° C., and 40° C., respectively.

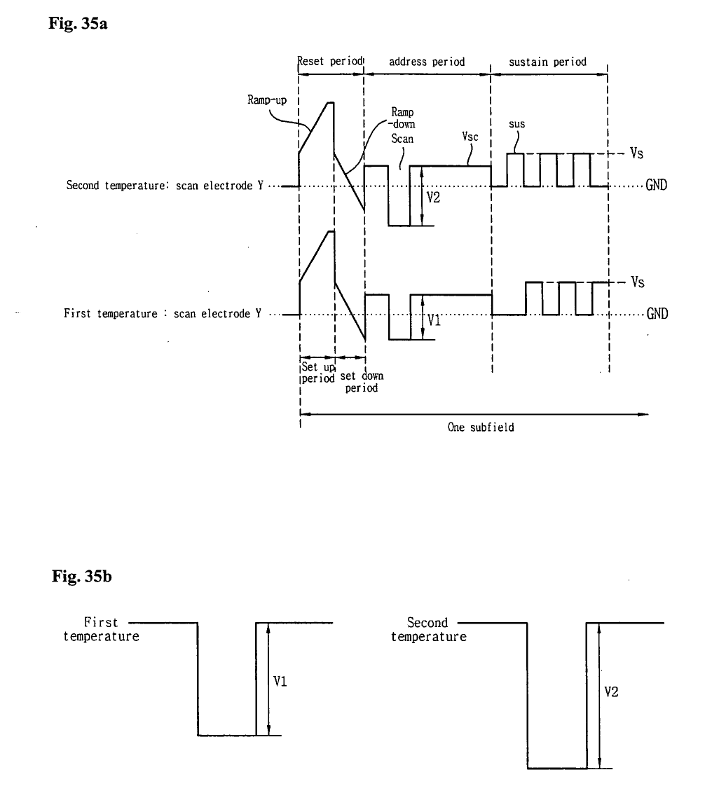

Next, an embodiment of varying a magnitude of voltage of a scan pulse supplied to a scan electrode Y according to the temperature of the plasma display panel in a driving method of a plasma display apparatus of the present invention will be described as follows with reference to FIGS. 35a and 35b.

FIGS. 35a and 35b are view for illustrating an embodiment of a method of varying a magnitude of voltage of a scan pulse supplied to a scan electrode Y according to temperature of a plasma display panel in a driving method of a plasma display apparatus of the present invention.

Firstly, referring to FIG. 35a, in the driving method of the plasma display apparatus of the present invention, when the scan pulse is supplied to the scan electrode Y in the address period, i.e. when the scan electrode Y is scanned, in case where the temperature of the plasma display panel is the first temperature, the magnitude of the voltage of the scan pulse supplied to the scan electrode Y upon scanning the scan electrode Y is made to be different from, in case where the temperature of the plasma display panel is the second temperature different from the first temperature, the magnitude of the voltage of the scan pulse supplied to the scan electrode Y. The difference in magnitude of voltage of scan pulse is described in more detailed in FIG. 35b.

Referring to FIG. 35b, assuming that the second temperature is higher than the first temperature among the first and second temperature of the plasma display panel, the magnitude of voltage V2 of pulse of the scan pulse supplied to the scan electrode Y in the second temperature is greater than the magnitude of voltage V1 of pulse of the scan pulse supplied to the scan electrode Y in the first temperature.

Here, it is preferred that the magnitude of voltage V2 of pulse of scan pulse supplied to scan electrode Y in the second temperature exceeds one time and less than 2 times of the magnitude of voltage V1 of pulse of scan pulse supplied to scan electrode Y in the first temperature. In other words, the following relation is obtained: V1<V2≦(1.5)V1.

As such, the reason why the magnitude of the voltage of the scan pulse supplied to scan electrode in the first and second temperature, respectively, is made to be different from each other will be described as follows.

In other words, to solve the problem as mentioned above is to increase the amount of wall charge 3300 formed in the discharge cell in the address period by causing the magnitude of the voltage of the scan pulse supplied to the scan electrode Y to be greater in case where the temperature of the plasma display panel is relatively high, and thus to cause sufficient amount of wall charges to be sustained in the discharge cell, although the recombination rate of the space charges 3301 and wall charges 3300 is increased. Thus, the undesired high temperature discharge is enhanced.

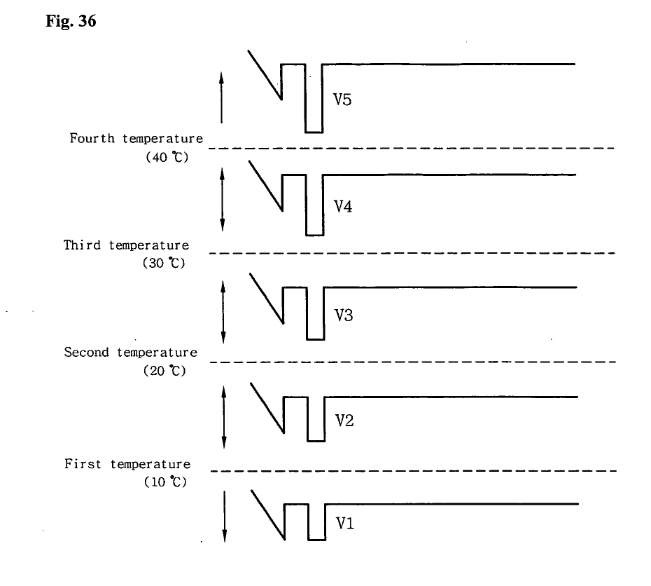

As such, it is possible to predefine a threshold temperature in case where the magnitude of the voltage of the scan pulse is adjusted according to the temperature of plasma display panel and then to adjust the magnitude of the voltage of the scan pulse in case where the temperature of plasma display panel exceeds the threshold temperature, which will be described as follows with reference to FIG. 36.

FIG. 36 illustrates an embodiment of a method of adjusting a magnitude of voltage of a scan pulse by establishing threshold temperature.

Referring to FIG. 36, the magnitude of the voltage of the scan pulse is adjusted by predefining the threshold temperature. For example, the threshold temperature is predefined as a first, a second, a third, and a fourth temperature, and the magnitude of the voltage of the scan pulse supplied to the scan electrode Y is indicated by V1 in case where the temperature of plasma display panel is less than the first temperature.

In addition, the magnitude of the voltage of the scan pulse supplied to the scan electrode Y is referred to as V2 being greater than V1 in case where the temperature of the plasma display panel is higher than the first temperature and lower than the second temperature.

In addition, the magnitude of the voltage of the scan pulse supplied to the scan electrode Y is referred to as V3 being greater than V2 in case where the temperature of the plasma display panel is higher than the second temperature and lower than the third temperature, the magnitude of the voltage of the scan pulse supplied to the scan electrode Y is referred to as V4 being greater than V3 in case where the temperature of the plasma display panel is higher than the third temperature and lower than the fourth temperature, and the magnitude of the voltage of the scan pulse supplied to the scan electrode Y is referred to as V5 being wider than V4 in case where the temperature of the plasma display panel is higher than the fourth temperature.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plurality of scan electrodes;
a plurality of data electrodes intersecting the plurality of scan electrodes;
a scan driver for scanning the scan electrode with one scan type among a plurality of scan types in which an order of scanning the plurality of scan electrodes is different from each other in an address period, and causing the width of the scan pulse supplied to a first scan electrode among the plurality of scan electrodes upon scanning the scan electrode to be different from the width of scan pulse supplied to a second scan electrode having a different scan order from the first scan electrode; and
a data driver for supplying a data pulse to the data electrode corresponding to the one scan type.

2. The plasma display apparatus as claimed in claim 1, wherein
the scan driver calculates the displacement current corresponding to each of the plurality of scan types depending on the inputted image data, and scans the scan electrode with one scan type having the lowest displacement current among the plurality of scan types.

3. The plasma display apparatus as claimed in claim 2, wherein
the scan electrode comprises a first and a second scan electrodes which are divided by a predetermined number of scan electrodes according to the scan types,
the data electrode comprises a first and a second data electrodes,
a first and a second discharge cells arranged in the intersecting portion of the first scan electrode and first and second data electrodes, and a third and a fourth discharge cells arranged in the intersecting portion of the second scan electrode and the first and second data electrodes are included,
the scan driver compares the data of the first to the fourth discharge cells and calculates the displacement current for the first discharge cell.

4. The plasma display apparatus as claimed in claim 3, wherein
the scan driver determines a first result which comes from the comparison of data of the first discharge cell with data of the second discharge cell, a second result which comes from the comparison of the data of the first discharge cell with the data of the third discharge cell, a third result which comes from the comparison of the data of the third discharge cell with the data of the fourth discharge cell, determines a productive equation of the displacement current depending to the combination of the first to third results, and produces a total displacement current of the first discharge cell by summing the displacement current determined using the determined productive equation.

5. The plasma display apparatus as claimed in claim 4, wherein
assuming that a capacitance between the adjacent data electrodes is Cm1, a capacitance between the data electrode and scan electrode and a capacitance between the data electrode and sustain electrode are Cm2,
the scan driver produces the displacement current according to the combination of the first to the third results based on the Cm1 and Cm2.

6. The plasma display apparatus as claimed in claim 2, wherein
the scan driver produces a displacement current for the plurality scan types in each subfield of one frame, and scans the scan electrode with the scan type having the lowest displacement current in each subfield.

7. The plasma display apparatus as claimed in claim 2, wherein
the scan type comprises a first scan type, the first scan type dividing the scan electrode into a plurality of groups to scan the scan electrode,
the scan driver continuously scans each scan electrode included in the same group in the first scan type, in case where the first scan type is the scan type having the lowest displacement current.

8. The plasma display apparatus as claimed in claim 1, wherein
the scan driver calculates a displacement current corresponding to each of the plurality of scan types depending on inputted image data, and scans the scan electrode with at least any one of scan types having the displacement current less than a predetermined threshold displacement current among the plurality of scan types.

9. The plasma display apparatus as claimed in claim 1, wherein
the first scan electrode precedes the second scan electrode in scan order, the scan driver causes the width of scan pulse supplied to the second scan electrode to be wider than the width of scan pulse supplied to the first scan electrode.

10. The plasma display apparatus as claimed in claim 9, wherein
the width of pulse of scan pulse supplied to the second scan electrode exceeds one time and is less than 2 times of the width of the scan pulse supplied to the first scan electrode.

11. A plasma display apparatus comprising:
a plurality of scan electrodes;
a plurality of data electrodes intersecting the plurality of scan electrodes;
a scan driver of scanning the scan electrode with one scan type among a plurality of scan types in which an order of scanning the plurality of scan electrodes is different from each other in an address period, and causing the magnitude of the voltage of the scan pulse supplied to a first scan electrode among the plurality of the scan electrodes upon scanning the scan electrode to be different from the magnitude of the voltage of the scan pulse supplied to a second scan electrode having a different scan order from the first scan electrode; and
a data driver of supplying a data pulse to the data electrode corresponding to the one scan type.

12. The plasma display apparatus as claimed in claim 11, wherein
the first scan electrode precedes the second scan electrode in scan order,
the scan driver causes the magnitude of the voltage of the scan pulse supplied to the second scan electrode to be more than the magnitude of the voltage of the scan pulse supplied to the first scan electrode.

13. The plasma display apparatus as claimed in claim 12, wherein
the magnitude of the voltage of the scan pulse supplied to the second scan electrode exceeds one time and is less than 1.5 times of the magnitude of the voltage of the scan pulse supplied to the first scan electrode.

14. A plasma display apparatus comprising:
a plasma display panel on which a plurality of scan electrodes are formed, and a plurality of data electrodes intersecting the plurality of scan electrodes are formed;
a scan driver of scanning the scan electrode with one scan type among a plurality of scan types in which an order of scanning the plurality of scan electrodes is different from each other in an address period, and causing, in case where the temperature of the plasma display panel is a first temperature, the width of the scan pulse supplied to the scan electrode upon scanning the scan electrode to be different from, in case where the temperature of the plasma display panel is a second temperature different from the first temperature, the width of scan pulse supplied to the scan electrode; and
a data driver of supplying a data pulse to the data electrode corresponding to the one scan type.

15. The plasma display apparatus as claimed in claim 14, wherein
the first temperature is less than the second temperature,
the scan driver causes the width of the scan pulse supplied to the scan electrode in the second temperature to be wider than the width of the scan pulse supplied to the scan electrode in the first temperature.

16. The plasma display apparatus as claimed in claim 15, wherein
the width of pulse of scan pulse supplied to the scan electrode in the second temperature exceeds one time and is less than 2 times of the width of the scan pulse supplied to the scan electrode in the first temperature.

17. A plasma display apparatus comprising:
a plasma display panel on which a plurality of scan electrodes are formed, and a plurality of data electrodes intersecting the plurality of scan electrodes are formed;
a scan driver of scanning the scan electrode with one scan type among a plurality of scan types in which an order of scanning the plurality of scan electrodes is different from each other in an address period, and causing, in case where the temperature of the plasma display panel is a first temperature, the magnitude of the voltage of the scan pulse supplied to the scan electrode upon scanning the scan electrode to be different from, in case where the temperature of the plasma display panel is a second temperature different from the first temperature, the magnitude of the voltage of the scan pulse supplied to the scan electrode; and
a data driver for supplying a data pulse to the data electrode corresponding to the one scan type.

18. The plasma display apparatus as claimed in claim 17, wherein
the first temperature is less than the second temperature,
the scan driver causes the magnitude of the voltage of the scan pulse supplied to the scan electrode in the second temperature to be more than the magnitude of the voltage of the scan pulse supplied to the scan electrode in the first temperature.

19. The plasma display apparatus as claimed in claim 18, wherein
the magnitude of the voltage of the scan pulse supplied to the scan electrode in the second temperature exceeds one time and is less than 1.5 times of the magnitude of the voltage of pulse of the scan pulse supplied to the scan electrode in the first temperature.

20. A plasma display apparatus comprising:
a plasma display panel on which a plurality of scan electrodes and a plurality of data electrodes intersecting the plurality of scan electrodes are formed;
a scan driver of causing the scan order of the plurality of scan electrodes to be different from a first data pattern in a second data pattern different from the first data pattern among the data patterns of inputted image data to scan the scan electrode, and causing the width of scan pulse supplied to a first scan electrode among the plurality of scan electrodes upon scanning the scan electrode to be different from the width of scan pulse supplied to a second scan electrode having a different scan order from the first scan electrode; and
a data driver for supplying a data pulse to the data electrode corresponding to the one scan type.
